(19) United States
(12) Patent Application Publication
(10) Pub. No.: US 2020/0036977 A1
(43) Pub. Date: Jan. 30, 2020

(54) PICTURE CODING DEVICE, PICTURE CODING METHOD, PICTURE CODING PROGRAM, PICTURE DECODING DEVICE, PICTURE DECODING METHOD, AND PICTURE DECODING PROGRAM

(71) Applicant: JVCKENWOOD Corporation, Yokohama-shi (JP)

(72) Inventors: Toru KUMAKURA, Yokohama-shi (JP); Shigeru FUKUSHIMA, Yokohama-shi (JP)

(21) Appl. No.: 16/594,117

(22) Filed: Oct. 7, 2019

Related U.S. Application Data
(63) Continuation of application No. PCT/JP2018/014113, filed on Apr. 2, 2018.

(30) Foreign Application Priority Data
Apr. 7, 2017 (JP) 2017-076559

(51) Int. Cl. H04N 19/119; H04N 19/159; H04N 19/176

(52) U.S. Cl. CPC H04N 19/119; H04N 19/176; H04N 19/159

(57) ABSTRACT

In a picture coding device that partitions difference coefficients, which are transform coefficients of differential signals between a picture to be coded and a prediction picture, into a plurality of sub-blocks and codes the difference coefficients sub-block by sub-block, a significant coefficient information coding controller and a calculation coder code significant coefficient information for every difference coefficient in a sub-block to be coded. A difference coefficient value information coding controller and a calculation coder code the value of a difference coefficient for each difference coefficient in the sub-block to be coded when the significant coefficient information is significant. The significant coefficient information coding controller determines context for coding significant coefficient information in the sub-block to be coded on the basis of information indicating significance of difference coefficients in coded sub-blocks adjacent to the sub-block to be coded in the horizontal and vertical directions.

### BACKGROUND OF THE INVENTION

### 1. Field of the Invention

The present invention relates to picture coding technology, and particularly to entropy coding technology for differential signals.

### 2. Description of the Related Art

In the international standards for moving picture coding, HEVC, context-adaptive arithmetic coding called CABAC is adopted as an entropy coding method. CABAC enables improvement of coding efficiency by managing a plurality of contexts, which are variables representing the probability of occurrence of bits to be coded, and by selecting the optimal context on the basis of neighboring coding/decoding results.

[patent document 1] JP2013-223029 A

Since CABAC derives the context on the basis of neighboring coding/decoding results, the context used in information to be coded/decoded cannot be confirmed until coding/decoding of the information to be referred to is completed. Since there is dependence between derivation of the context and the coding/decoding processing, it is difficult to perform parallel processing on these, which is a factor that hinders the speeding up of the processing.

JP 2013-223029 A discloses how to derive the context to be coded/decoded on the basis of information belonging to a coded/decoded sub-block with respect to significant coefficient information among elements included in difference information. According to the disclosed technology, it is possible to derive the context for coding/decoding significant coefficient information by referring to coding/decoding result of the information belonging to the coded/decoded sub-block without referring to a coding/decoding result of the sub-block to which the significant coefficient information to be coded/decoded belongs. Therefore, it is possible to derive contexts for coding/decoding all pieces of significant coefficient information belonging to the sub-block to be coded/decoded, irrespective of the dependency at the time of start of the coding/decoding processing of the sub-block to be coded/decoded.

In JP 2013-223029 A, the scanning order of sub-blocks and significant coefficient information in the sub-blocks is from right to left and from bottom to top. This scanning order follows the HEVC standards. However, it is desirable that the scanning order of sub-blocks be determined as appropriate after comprehensive consideration of factors such as the coding efficiency, complexity, and functions to be provided. In a case where sub-blocks and significant coefficient information in the sub-blocks are scanned from left to right and from top to bottom contrary to the configuration of JP 2013-223029 A, the following disadvantages occur.

According to the configuration disclosed in JP 2013-223029 A but with the scanning order of sub-blocks being left to right and from top to bottom, the context for coding/decoding significant coefficient information is determined depending on the vertical position of the sub-block to be coded/decoded in a case where significant sub-block information of the sub-block neighboring on the left of the sub-block to be coded/decoded is 1 and significant sub-block information of the sub-block neighboring on top of the sub-block to be coded/decoded is 0.

However, in a case where the significant sub-block information of the sub-block neighboring on the left of the sub-block to be coded/decoded is 1 and the significant sub-block information of the sub-block neighboring on top of the sub-block to be coded/decoded is 0, it is estimated that the probability for low-frequency significant coefficient information in the horizontal direction of the sub-block to be coded/decoded to be 1 becomes high since there is a non-zero difference coefficient in the left sub-block, and that the probability that high-frequency significant coefficient information in the horizontal direction to be 0 becomes high. In the configuration of JP 2013-223029 A, it is not possible to switch contexts depending on the horizontal position of significant coefficient information.

The same applies to a case where significant sub-block information of the sub-block neighboring on the left of a sub-block to be coded/decoded is 0 and significant sub-block information of the sub-block neighboring on top of the sub-block to be coded/decoded is 1. Therefore, the coding efficiency is disadvantageously impaired.

### SUMMARY OF THE INVENTION

The present invention has been made in view of such circumstances, and an object of the present invention is to provide picture coding technology which has a simple circuit configuration and is suitable for real-time processing, and implements a context index calculation method capable of performing parallel processing with a reduced amount of calculation even in a configuration in which sub-blocks are scanned from left to right and from top to bottom in difference coefficient coding/decoding. Another object is to provide picture coding technology with high coding efficiency by implementing calculation of a context index with reference to a neighboring difference coefficient that is appropriate in terms of correlation.

In order to solve the above disadvantage, a picture coding device according to an aspect of the present invention partitions difference information between a picture to be coded and a picture to be predicted into a plurality of sub-blocks and to code the partitioned sub-blocks in an order from left to right and from top to bottom, the picture coding device including: a significant sub-block information coder that codes significant sub-block information indicating whether all values of difference coefficients belonging to a sub-block are zero; a significant coefficient information coder that codes significant coefficient information indicating whether a value of a difference coefficient is zero; a difference coefficient value information coder that codes the value of the difference coefficient; and a context deriver that derives a context for coding the significant coefficient information to be coded on the basis of significant sub-block information of a coded sub-block adjacent on a left of a sub-block to be coded, significant sub-block information of a coded sub-block adjacent on top of the sub-block to be coded, and a position of the difference coefficient to be coded in the sub-block to be coded, in which the context deriver derives the context of the significant coefficient information to be coded on the basis of a horizontal position of the significant coefficient information to be coded in the sub-block to be coded in a case where the significant sub-block information of the coded sub-block adjacent on the left is one and the significant sub-block information of the coded sub-block adjacent on top is zero, and derives the context of the significant coefficient information to be coded on the basis of a vertical position of the significant coefficient information to be coded in the sub-block to be coded in a case where the significant sub-block information of the coded sub-block adjacent on the left is zero and the significant sub-block information of the coded sub-block adjacent on top is one.

Another aspect of the present invention is a picture coding method. The picture coding method partitions difference information between a picture to be coded and a picture to be predicted into a plurality of sub-blocks and codes the partitioned sub-blocks in an order from left to right and from top to bottom, the picture coding method including: a significant sub-block information coding step of coding significant sub-block information indicating whether all values of difference coefficients belonging to a sub-block are zero; a significant coefficient information coding step of coding significant coefficient information indicating whether a value of a difference coefficient is zero; a difference coefficient value information coding step of coding the value of the difference coefficient; and a context deriving step of deriving context for coding the significant coefficient information to be coded on the basis of significant sub-block information of a coded sub-block adjacent on a left of a sub-block to be coded, significant sub-block information of a coded sub-block adjacent on top of the sub-block to be coded, and a position of the difference coefficient to be coded in the sub-block to be coded, in which the context deriving step derives the context of the significant coefficient information to be coded on the basis of a horizontal position of the significant coefficient information to be coded in the sub-block to be coded in a case where the significant sub-block information of the coded sub-block adjacent on the left is one and the significant sub-block information of the coded sub-block adjacent on top is zero, and derives the context of the significant coefficient information to be coded on the basis of a vertical position of the significant coefficient information to be coded in the sub-block to be coded in a case where the significant sub-block information of the coded sub-block adjacent on the left is zero and the significant sub-block information of the coded sub-block adjacent on top is one.

Another aspect of the present invention is a picture coding method. This method is a picture coding method that partitions difference coefficients, which are transform coefficients of differential signals between a picture to be coded and a prediction picture, into a plurality of sub-blocks and codes the difference coefficients sub-block by sub-block, the picture coding method including: a significant coefficient information coding step of coding significant coefficient information indicating that the value of a difference coefficient is nonzero and is significant for each difference coefficient in a sub-block to be coded; and a difference coefficient value information coding step of coding the value of the difference coefficient in a case where the significant coefficient information is significant. The significant coefficient information coding step determines context for coding the significant coefficient information in the sub-block to be coded on the basis of information indicating significance of a difference coefficient in a coded sub-block adjacent to the sub-block to be coded in the horizontal direction and information indicating significance of a difference coefficient in a coded sub-block adjacent to the sub-block to be coded in the vertical direction.

Another aspect of the present invention is a picture decoding device. This picture decoding device decodes a bitstream obtained by partitioning difference information between a picture to be decoded and a picture to be predicted into a plurality of sub-blocks and coding the partitioned sub-blocks in an order from left to right and from top to bottom, the picture decoding device including: a significant sub-block information decoder that decodes significant sub-block information indicating whether all values of difference coefficients belonging to the sub-block are zero; a significant coefficient information decoder that decodes significant coefficient information indicating whether a value of a difference coefficient is zero; a difference coefficient value information decoder that decodes the value of the difference coefficient; and a context deriver that derives context for decoding the significant coefficient information to be decoded on the basis of significant sub-block information of a decoded sub-block adjacent on a left of a sub-block to be decoded, significant sub-block information of a decoded sub-block adjacent on top of the sub-block to be decoded, and a position of the difference coefficient to be decoded in the sub-block to be decoded, in which the context deriver derives the context of the significant coefficient information to be decoded on the basis of a horizontal position of the significant coefficient information to be decoded in the sub-block to be decoded in a case where the significant sub-block information of the decoded sub-block adjacent on the left is one and the significant sub-block information of the decoded sub-block adjacent on top is zero, and derives the context of the significant coefficient information to be decoded on the basis of a vertical position of the significant coefficient information to be decoded in the sub-block to be decoded in a case where the significant sub-block information of the decoded sub-block adjacent on the left is zero and the significant sub-block information of the decoded sub-block adjacent on top is one.

Another aspect of the present invention is a picture decoding method. The picture decoding method decodes a bitstream obtained by partitioning difference information between a picture to be decoded and a picture to be predicted into a plurality of sub-blocks and coding the partitioned sub-blocks in an order from left to right and from top to bottom, the picture decoding method including: a significant sub-block information decoding step of decoding significant sub-block information indicating whether all values of difference coefficients belonging to the sub-block are zero; a significant coefficient information decoding step of decoding significant coefficient information indicating whether a value of a difference coefficient is zero; a difference coefficient value information decoding step of decoding the value of the difference coefficient; and a context deriving step of deriving context for decoding the significant coefficient information to be decoded on the basis of significant sub-block information of a decoded sub-block adjacent on a left of a sub-block to be decoded, significant sub-block information of a decoded sub-block adjacent on top of the sub-block to be decoded, and a position of the difference coefficient to be decoded in the sub-block to be decoded, in which the context deriving step derives the context of the significant coefficient information to be decoded on the basis of a horizontal position of the significant coefficient information to be decoded in the sub-block to be decoded in a case where the significant sub-block information of the decoded sub-block adjacent on the left is one and the significant sub-block information of the decoded sub-block adjacent on top is zero, and derives the context of the significant coefficient information to be decoded on the basis of a vertical position of the significant coefficient information to be decoded in the sub-block to be decoded in a case where the significant sub-block information of the decoded sub-block adjacent on the left is zero and the significant sub-block information of the decoded sub-block adjacent on top is one.

Note that any combination of the above components as well as those in which representation of the present invention is converted among a method, a device, a system, a recording medium, a computer program, or the like are also valid as one aspect of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a flowchart for explaining a decoding procedure of a difference coefficient;

FIG. 2 is a diagram for explaining the scanning order of sub-block difference coefficients;

FIG. 3 is a flowchart for explaining a decoding procedure of sub-block difference coefficients;

FIG. 4 is a flowchart for explaining a decoding procedure of difference coefficient value information;

FIG. 5 is a block diagram illustrating a configuration of a picture coding device for executing coding of difference coefficients according to an embodiment;

FIG. 6 is a block diagram illustrating a configuration of a picture decoding device for executing decoding of difference coefficients according to an embodiment;

FIG. 7 is a diagram for explaining the size of coding blocks;

FIG. 8 is a block diagram illustrating a detailed configuration of a first example of the picture coding device in FIG. 5;

FIG. 9 is a flowchart for explaining a coding procedure of difference coefficients in the first example;

FIG. 10 is a flowchart for explaining a coding procedure of sub-block difference coefficients in the first example;

FIG. 11 is a flowchart for explaining a coding procedure of significant coefficient information in the first example;

FIG. 12 is a diagram for explaining a context definition of significant coefficients in the first example;

FIG. 13 is a diagram for explaining a different example of a context definition of significant coefficients in the first example;

FIG. 14 is a flowchart for explaining a coding procedure of difference coefficient value information in the first example;

FIG. 15 is a block diagram illustrating a detailed configuration of a first example of the picture decoding device in FIG. 6;

FIG. 16 is a flowchart for explaining a decoding procedure of significant coefficient information in the first example;

FIG. 17 is a diagram for explaining a different example of the scanning order of significant coefficients in the first example;

FIG. 18 is a flowchart for explaining a coding procedure of significant coefficient information in a second example; and

FIG. 19 is a flowchart for explaining a decoding procedure of significant coefficient information in the second example.

### DETAILED DESCRIPTION OF THE INVENTION

The invention will now be described by reference to the preferred embodiments. This does not intend to limit the scope of the present invention, but to exemplify the invention.

First, premised technology of an embodiment of the present invention will be described.

CABAC optimizes code assignment by associating a plurality of contexts with each coding syntax and selecting the context based on a correlation of syntax elements.

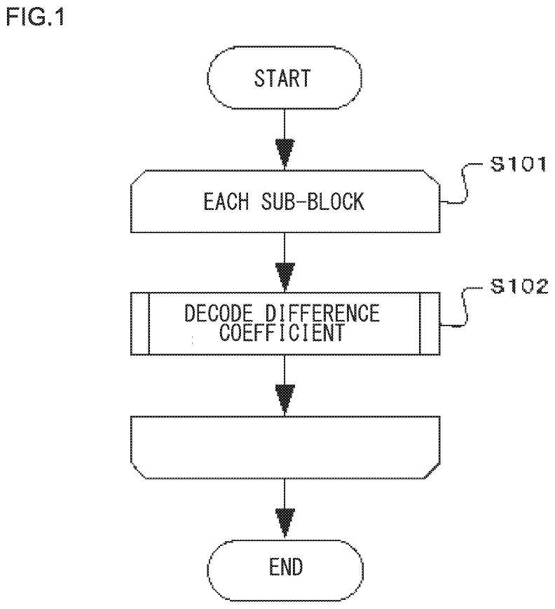

A decoding procedure by CABAC of quantized orthogonal transform coefficients of differential signals coded in a size of 16×16 will be described with reference to a flowchart of FIG. 1. Hereinafter, a quantized orthogonal transform coefficient is referred to as a difference coefficient. In this procedure, 16×16 difference coefficients as processing targets are partitioned into sub-blocks 401 to 416 each sized 4×4, and scanning sub-block by sub-block is preferentially performed. Note that the size of difference coefficients as processing targets and the size of sub-blocks are not limited to the above sizes. For example, difference coefficients may be sized as large as 64×64 or 32×32, or may be sized as small as 8×8.

In the following description, it is assumed that each difference coefficient is coded/decoded by significant coefficient information and difference coefficient value information. Significant coefficient information is a single bit flag for indicating whether the difference coefficient is 0. Significant coefficient information being 1 indicates that the related difference coefficient is nonzero. For a difference coefficient whose significant coefficient information is 1, a specific value of the difference coefficient is coded/decoded as difference coefficient value information. Difference coefficient value information further includes difference coefficient absolute value information and difference coefficient sign information.

Note that since it is assured that a difference coefficient is nonzero when significant coefficient information is 1, difference coefficient absolute value information is a value obtained by subtracting 1 from the absolute value of the difference coefficient to be coded/decoded.

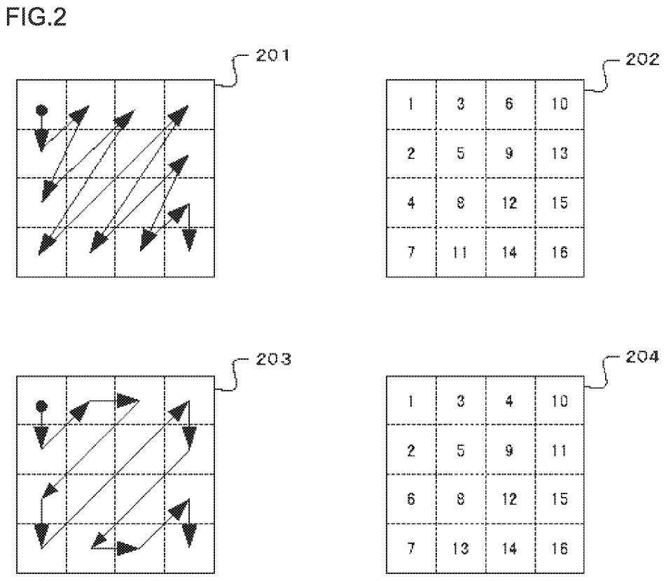

Sub-blocks to be processed are determined according to a scanning order described later (S101). If all the sub-blocks have been scanned, decoding processing of difference coefficients is terminated. A scanning order 202 of sub-blocks is illustrated in FIG. 2. In this procedure, scanning starts from the top left sub-block of the difference coefficient area, then is performed in accordance with the rule of from left to right and from top to bottom, and completes at the bottom right sub-block. Reference numeral 201 denotes a diagram representing the scanning order 202 using arrows. When the scanning order 202 is followed, processing of sub-blocks located spatially on the left and on top of the sub-block to be processed is completed for all sub-blocks to be processed. The scanning order according to the rule of from left to right and from top to bottom is not limited to the above example, and for example, a scanning order 204 illustrated in FIG. 2 is also conceivable. Reference numeral 203 denotes a diagram representing the scanning order 204 using arrows. Also in this case, the state is maintained in which scanning of sub-blocks located spatially on the left and on top of a sub-block to be processed is completed for all sub-blocks to be processed.

Returning to the flowchart of FIG. 1, decoding processing is performed on all the difference coefficients of a sub-block to be processed (S102). After decoding of the sub-block difference coefficients is completed, the flow proceeds to step S101.

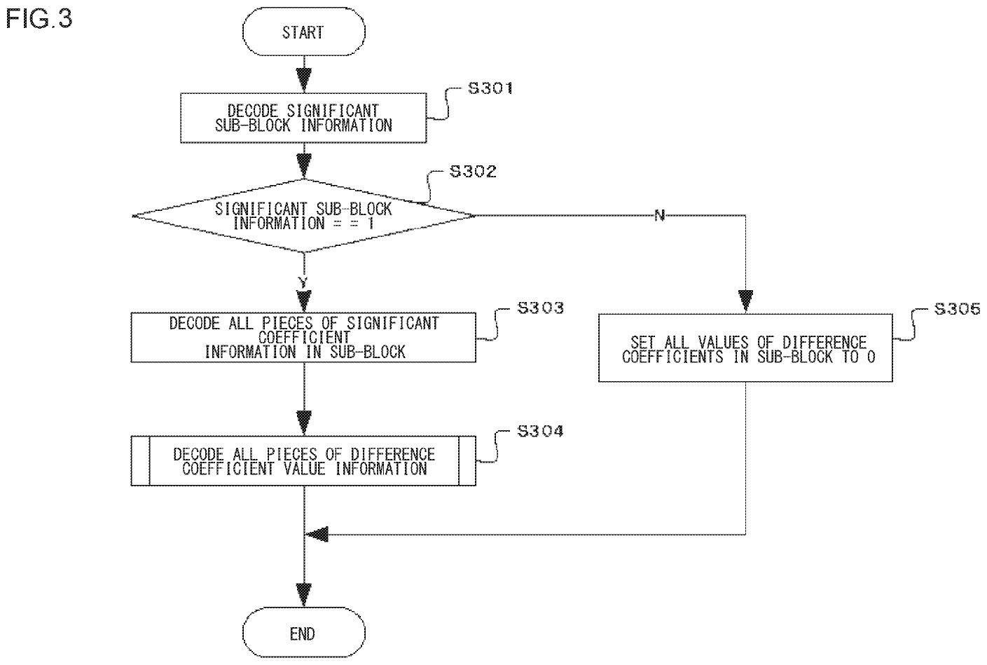

Details of the decoding processing of the sub-block difference coefficients will be described with reference to a flowchart of FIG. 3.

Significant sub-block information is decoded (S301). Significant sub-block information is a 1-bit flag for indicating that there is a non-zero difference coefficient in a sub-block to be processed. Significant sub-block information of 1 indicates that there is at least one non-zero difference coefficient in the sub-block to be processed. Significant sub-block information of 0 indicates that the value of all difference coefficients of the sub-block to be processed is 0.

The value of the significant sub-block information is determined (S302). If the significant sub-block information is 0, all difference coefficient values of the sub-block to be processed are set to 0 (S305), and the decoding processing of the sub-block difference coefficients is terminated.

If the significant sub-block information is 1, decoding processing is performed on all pieces of significant coefficient information of the sub-block to be processed (S303). Significant coefficient information is a 1-bit flag for indicating that the value of a difference coefficient at a processing target position is nonzero. Significant coefficient information of 1 indicates that the value of the difference coefficient at a processing target position is nonzero, and significant coefficient information of 0 indicates that the value of the difference coefficient at a processing target position is 0. It is assumed that the scanning order of significant coefficient information follows the scanning order 202 illustrated in FIG. 2 like the scanning order of the sub-blocks in the difference coefficient area. Prior to decoding of significant coefficient information, the context is derived on the basis of predetermined processing that refers to the decoding result. After decoding of all pieces of significant coefficient information of the sub-block is completed, the flow proceeds to decoding of difference coefficient value information in step S304.

Decoding processing is performed on difference coefficient value information (S304). Details of the decoding processing of the difference coefficient value information will be described later. After the decoding processing of the difference coefficient value information is completed, the flow proceeds to step S101, and a next sub-block is scanned.

### Decoding Processing Procedure of Difference Coefficient Value Information

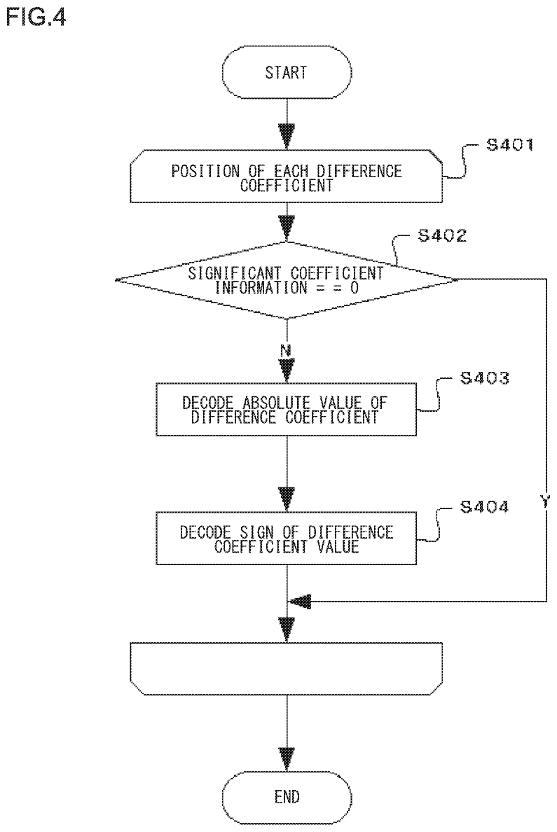

The decoding procedure of the sub-block difference coefficient value information in step S304 of the flowchart of FIG. 3 will be described with reference to a flowchart of FIG. 4.

A difference coefficient to be processed is determined in accordance with a predetermined scanning order (S401). It is assumed that the scanning order of difference coefficients in a sub-block follows the scanning order 202 illustrated in FIG. 2 like the scanning order of significant coefficient information. If all the difference coefficients of the sub-block have been scanned, decoding processing of the difference coefficient value information is terminated, and the flow proceeds to a determination procedure of a next sub-block (S101).

It is determined whether significant coefficient information of a difference coefficient to be processed is 0 (S402). If the significant coefficient information of the difference coefficient to be processed is 0, decoding of difference coefficient value information at the position of the difference coefficient to be processed is completed, and the flow proceeds to step S401.

If the significant coefficient information of the difference coefficient to be processed is 1, difference coefficient absolute value information of the difference coefficient to be processed is decoded (S403). When this procedure is executed, it is assured that the value of the difference coefficient is nonzero, and difference coefficient absolute value information is obtained by coding a value obtained by subtracting 1 from the absolute value of the difference coefficient. Therefore, a value obtained by adding 1 to the difference coefficient absolute value information is set to the absolute value of the difference coefficient.

Difference coefficient sign information of the difference coefficient to be processed is decoded (S404). In a case where the difference coefficient sign information is 0, the sign of the value of the difference coefficient is set to be positive, and in a case where the difference coefficient sign information is 1, the sign of the value of the difference coefficient is set to be negative.

In the following description, a “processing target block” refers to a block to be coded in a picture coding device, but in a picture decoding device, refers to a block to be decoded. Likewise, a “processed block” refers to a coded block in a picture coding device, but in a picture decoding device, refers to a decoded block. Hereinafter, the term is used in the above meaning unless otherwise specified.

### Coding Device

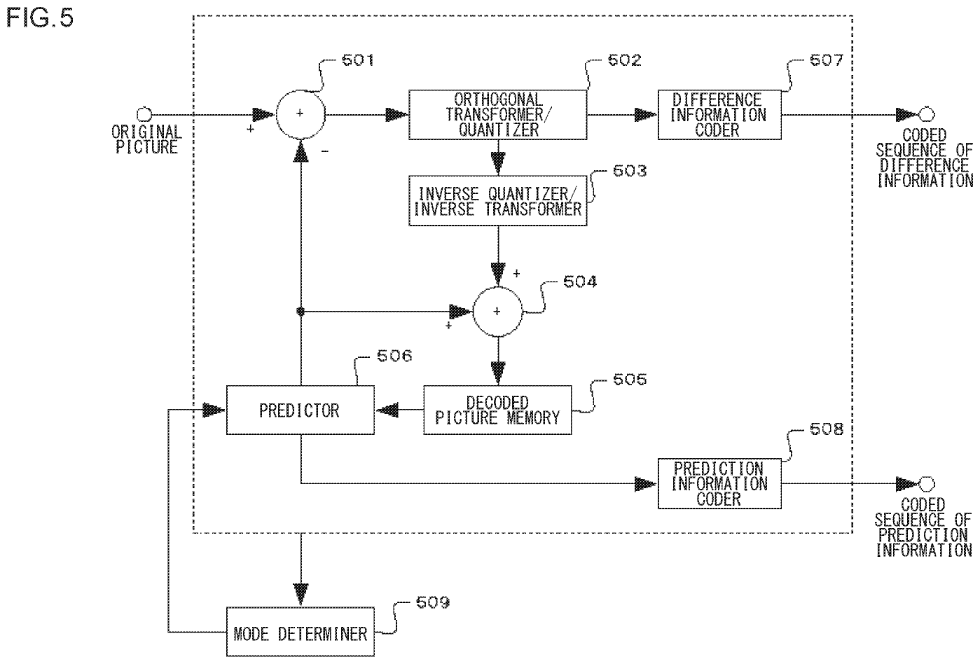

A preferable picture coding device for carrying out the present invention will be described with reference to the drawings. FIG. 5 is a block diagram illustrating a configuration of a picture coding device according to an embodiment. The picture coding device according to the embodiment includes a subtractor 501, an orthogonal transformer/quantizer 502, an inverse quantizer/inverse transformer 503, an adder 504, a decoded picture memory 505, a predictor 506, a difference information coder 507, a prediction information coder 508, and a mode determiner 509.

The mode determiner 509 attempts to code all prediction candidates and determines the optimal prediction information for each block of a picture. Prediction information includes a partitioned block size and a prediction mode indicating inter prediction/intra prediction, and further includes motion information such as a motion vector and a reference picture index when the prediction mode is inter prediction, or when the prediction mode is intra prediction, includes an intra prediction mode. The determined prediction information is provided to the predictor 506 and the prediction information coder 508.

The prediction information coder 508 performs variable length coding on the input prediction information and outputs a coded sequence of the prediction information.

The predictor 506 generates a prediction picture using the input prediction information and a decoded picture stored in the decoded picture memory 505, and provides the generated prediction picture to the subtractor 501.

The subtractor 501 generates a difference picture by subtracting the prediction picture from the original picture to be coded, and provides generated differential signals to the orthogonal transformer/quantizer 502.

The orthogonal transformer/quantizer 502 generates difference coefficients by performing orthogonal transform/quantization on the difference picture, and provides the generated difference coefficients to the inverse quantizer/inverse transformer 503 and the difference information coder 507.

The difference information coder 507 performs entropy coding on the difference coefficients and outputs a coded sequence of difference information.

The inverse quantizer/inverse transformer 503 performs inverse quantization/inverse orthogonal transform on the difference coefficients received from the orthogonal transformer/quantizer 502 to generate decoded differential signals, and provides the generated decoded differential signals to the adder 504.

The adder 504 adds the prediction picture and the decoded differential signals to generate a decoded picture, and stores the generated decoded picture in the decoded picture memory 505.

### Decoding Device

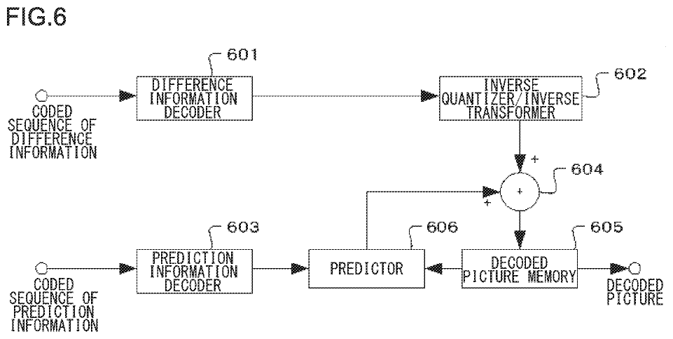

A preferable picture decoding device for carrying out the present invention will be described with reference to the drawings. FIG. 6 is a block diagram illustrating a configuration of a picture decoding device according to an embodiment. The picture decoding device according to the embodiment includes a difference information decoder 601, an inverse quantizer/inverse transformer 602, a prediction information decoder 603, an adder 604, a decoded picture memory 605, and a predictor 606.

Decoding processing of the picture decoding device in FIG. 6 corresponds to the decoding processing included inside the picture coding device in FIG. 5, and thus the inverse quantizer/inverse transformer 602, the adder 604, the decoded picture memory 605, and the predictor 606 in FIG. 6 have functions corresponding to those of the inverse quantizer/inverse transformer 503, the adder 504, the decoded picture memory 505, and the predictor 506 of the picture coding device in FIG. 5, respectively.

The prediction information decoder 603 performs entropy decoding on the input coded sequence of the prediction information to generate prediction information, and provides the generated prediction information to the predictor 606.

The predictor 606 generates a prediction picture using the input prediction information and a decoded picture stored in the decoded picture memory 605, and provides the generated prediction picture to the adder 604.

The difference information decoder 601 generates difference information by performing entropy decoding on difference information. The generated difference information is provided to the inverse quantizer/inverse transformer 602.

The inverse quantizer/inverse transformer 602 performs inverse quantization/inverse orthogonal transform on the difference information received from the difference information decoder 601 to generate decoded differential signals, and provides the generated decoded differential signals to the adder 604.

The adder 604 adds the prediction picture and the decoded differential signals to generate a decoded picture, and stores the generated decoded picture in the decoded picture memory 605 and outputs the generated decoded picture.

The difference coefficient coding and decoding processing according to the embodiment of the present invention is performed in the difference information coder 507 of the picture coding device in FIG. 5 and the difference information decoder 601 of the picture decoding device in FIG. 6. Details of coding and decoding processing of difference information according to the embodiment will be described below.

### Coding Block

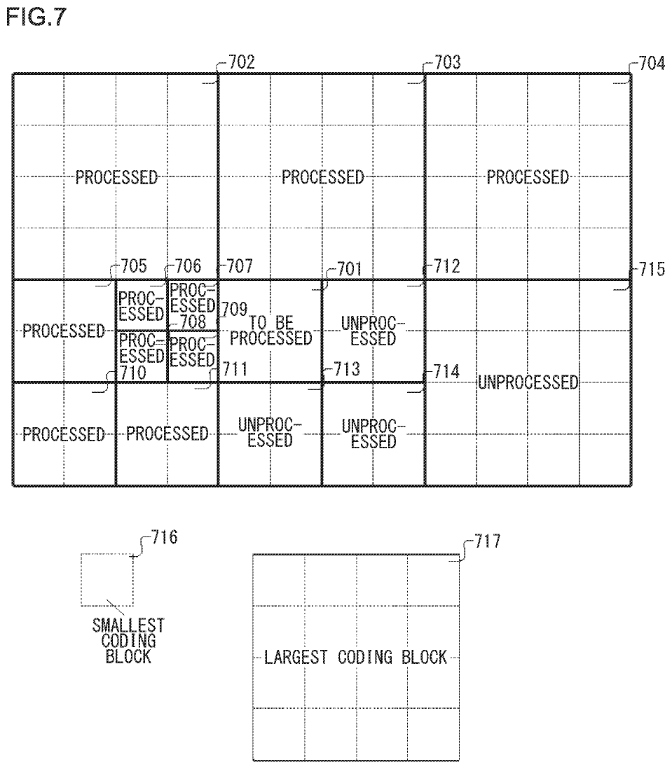

In an embodiment, a screen is hierarchically partitioned into rectangular blocks as illustrated in FIG. 7, and each block is sequentially processed in a predetermined processing order. Each of the blocks to be partitioned is called a coding block. A block 717 in FIG. 7 is the largest unit of partition in the embodiment, and this is called a largest coding block. A block 716 in FIG. 7 is a smallest unit of partition in the embodiment, and this is called a smallest coding block. Hereinafter, description is given assuming that the smallest coding block is 4×4 pixels and the largest coding block is 16×16 pixels.

### Prediction Block

Of the coding blocks, a unit for performing intra prediction is called a prediction block. The prediction block may have any size larger than or equal to the smallest coding block and less than or equal to the largest coding block. A block 701 in FIG. 7 is a processing target block, and blocks 702 to 711 preceding the block 701 in a predetermined processing order are processed blocks. Prediction blocks are confirmed for these blocks, and blocks 702, 703, and 704 are sized 16×16, blocks 705, 710, 711, and 701 are sized 8×8, and blocks 706, 707, 708, and 709 are sized 4×4. Blocks 712, 713, 714, and 715 are unprocessed, and the coding block size is not yet confirmed. In a coding procedure, an optimal prediction block size is determined, and the prediction block size is coded. In a decoding procedure, the prediction block size is obtained from the bit stream. Hereinafter, description is given assuming that a prediction block is a processing unit.

### Processing Unit of Difference Coefficient

It is assumed that the unit for performing quantization/orthogonal transform is the same as the unit of prediction blocks; however in the coding/decoding processing, the difference coefficient area is partitioned into a plurality of sub-blocks and scanned. It is assumed that the size of a sub-block is 4×4. However, the unit for performing quantization/orthogonal transform may be determined independently of the unit of prediction blocks.

### First Example

### Coding Procedure

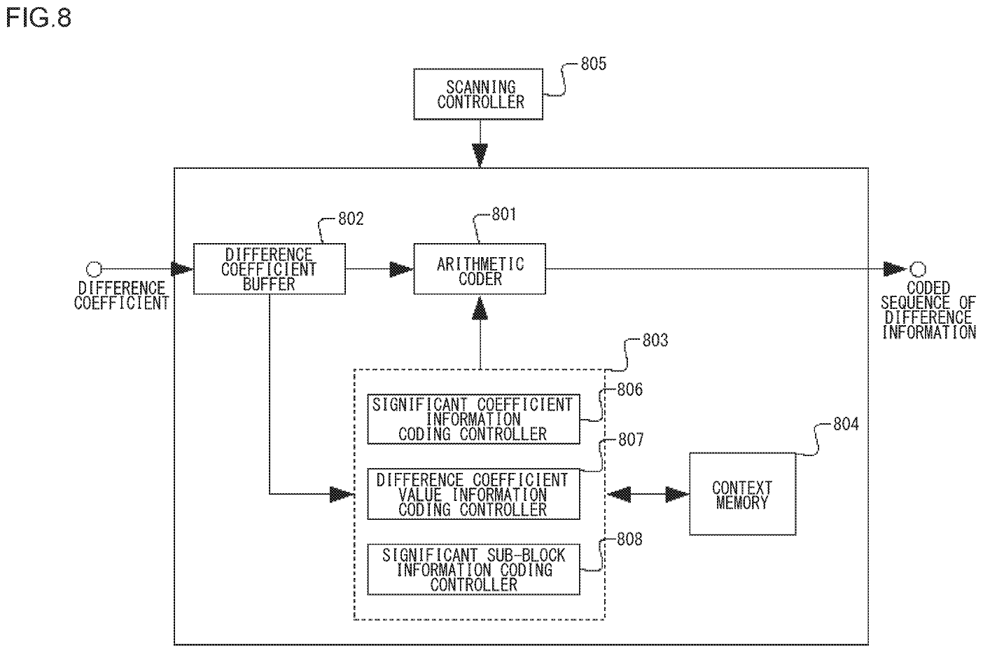

A first example of the difference information coding method according to the embodiment of the present invention will be described. FIG. 8 is a block diagram of a detailed configuration of the first example of the difference information coder 507 in FIG. 5. A difference information coder 507 of the first example includes an arithmetic coder 801, a difference coefficient buffer 802, a coding controller 803, a context memory 804, and a scan controller 805, and the coding controller 803 further includes a significant coefficient information coding controller 806, a difference coefficient value information coding controller 807, and a significant sub-block information coding controller 808.

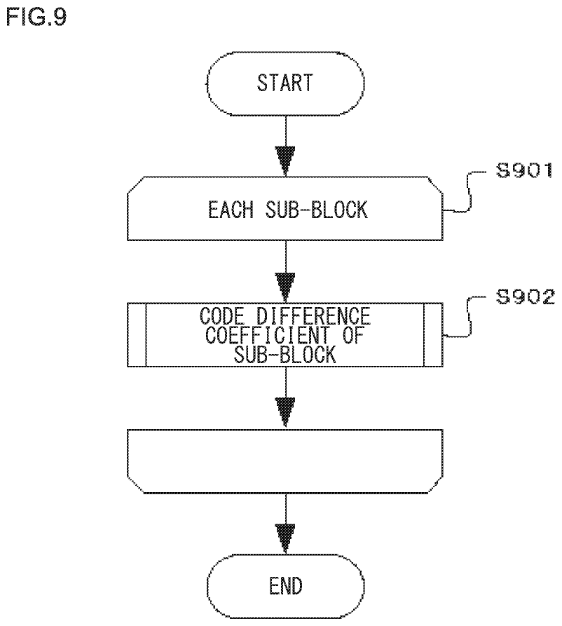

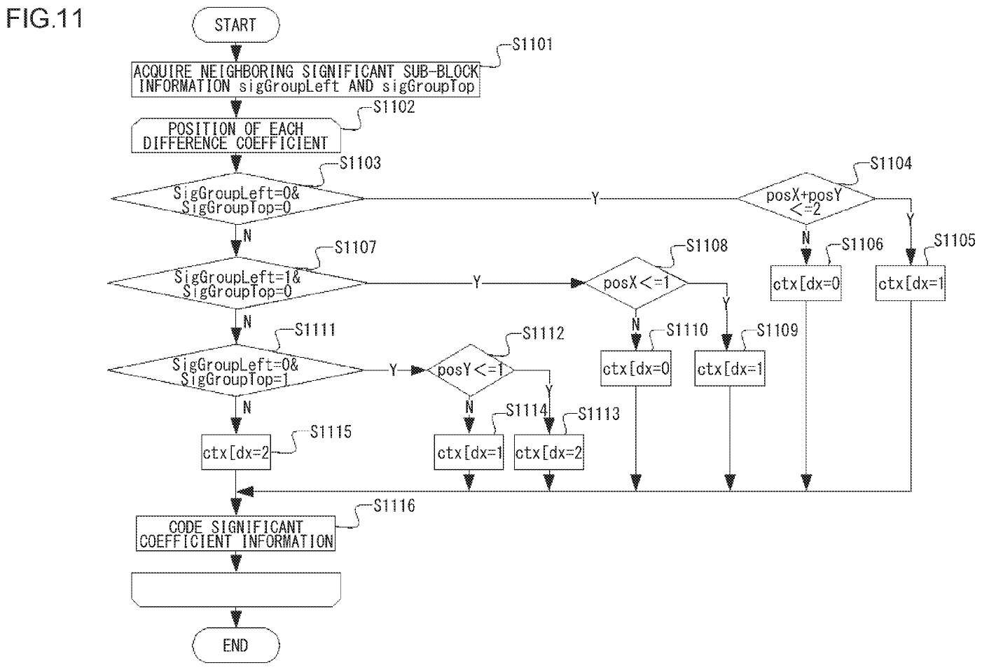

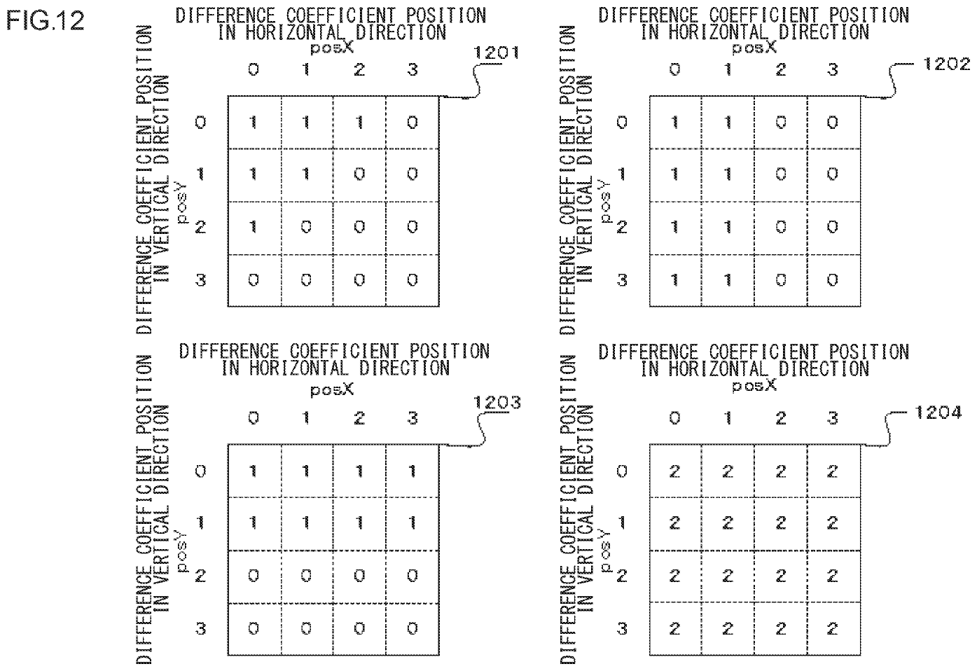

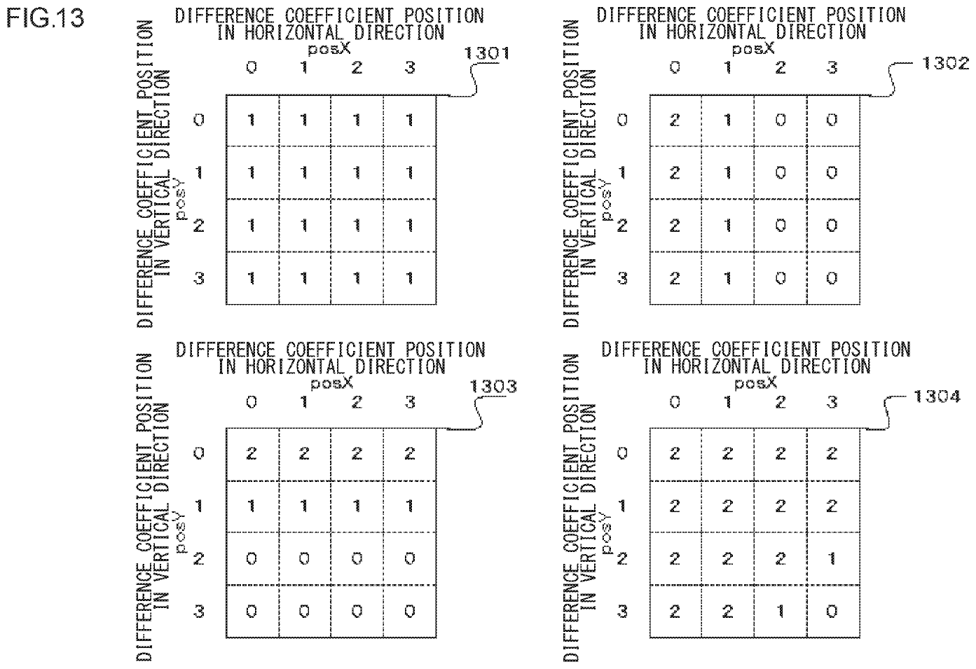

Hereinafter, the coding procedure of difference coefficients will be described with reference to flowcharts of FIGS. 9, 10, 11, and 14 and context definitions of FIGS. 12 and 13.

The scan controller 805 determines a sub-block to be processed (S901). If all the sub-blocks have been scanned, decoding processing of difference coefficients is terminated. It is assumed that the scanning order of a sub-block follows the scanning order 202 in FIG. 2. In this procedure, scanning starts from the top left sub-block of the difference coefficient area, then is performed in accordance with the rule of from left to right and from top to bottom, and completes at the bottom right sub-block. As described above, the context is updated in the process of coding. When the scanning order 202 in FIG. 2 is followed, processing of sub-blocks located spatially on the left and on top of the sub-block to be processed is completed. The sub-block coding processing is performed on the sub-block to be processed (S902).

### Sub-Block Coding Procedure (S902)

The significant sub-block information coding controller 808 acquires a sub-block to be processed from the difference coefficient buffer 802. If all the difference coefficients of the sub-block have been scanned and the values of all the difference coefficients are 0, significant sub-block information is set to 0. In other cases (if there is at least one difference coefficient the value of which is nonzero), the significant sub-block information is set to 1 (S1001).

The significant sub-block information coding controller 808 refers to difference coefficients included in coded sub-blocks that are adjacent to the sub-block to be processed from the difference coefficient buffer 802, and determines a context index ctxIdx that is a variable indicating the context for coding the significant sub-block information. The context corresponding to the context indectxIdx is read from the context memory 804. The significant sub-block information and the context are sent to the arithmetic coder 801. The arithmetic coder 801 codes the significant sub-block information using the context (S1002).

The significant sub-block information coding controller 808 determines the value of the significant sub-block information (S1003). If the significant sub-block information is 0, the sub-block difference coefficient coding processing is terminated, and the flow proceeds to step S901.

If the significant sub-block information is 1, coding processing is performed on all pieces of significant coefficient information of the sub-block to be processed (S1004). Details of the coding procedure of the significant coefficient information will be described later. After coding of all the pieces of significant coefficient information of the sub-block has been completed, the flow proceeds to coding of difference coefficient value information in step S1005.

The difference coefficient value information coding controller 807 performs coding processing on all pieces of difference coefficient value information of the sub-block to be processed (S1005). Details of the coding procedure of the difference coefficient value information of the sub-block will be described later. After coding of all the pieces of difference coefficient value information of the sub-block has been completed, the flow proceeds to step S901.

### Coding Processing Procedure of Significant Coefficient Information (S1004)

The significant coefficient information coding controller 806 acquires significant sub-block information of decoded sub-blocks adjacent on the left and on top of the sub-block to be processed as neighboring significant sub-block information. Let the significant sub-block information of the sub-block adjacent on the left be sigGroupLeft, and the significant sub-block information of the sub-block adjacent under be sigGroupTop (S1101).

The significant coefficient information coding controller 806 determines a difference coefficient to be processed (S1102). The scanning order of difference coefficients in the sub-block follows the scanning order 202 illustrated in FIG. 2 like the scanning order of the sub-blocks in the difference coefficient area. If all pieces of the significant coefficient information of the sub-block have been scanned, the coding processing of the significant coefficient information is terminated, and the flow proceeds to the coding procedure of the difference coefficient value information (S1005).

The significant coefficient information coding controller 806 evaluates the neighboring significant sub-block information sigGroupLeft and sigGroupTop (S1103).

If both sigGroupLeft and sigGroupTop are 0, the position of the difference coefficient to be processed in the sub-block to be processed is determined (S1104). Let the horizontal position of a difference coefficient be posX, the vertical position of the difference coefficient be posY, and the position of the difference coefficient to be processed be pos=posX+posY. If pos<=2 holds, the context index ctxIdx for coding the significant coefficient information is set to 1 (S1105), and if not (pos>2), the context index ctxIdx is set to 0 (S1106). The definition of the context index ctxIdx in a case where sigGroupLeft and sigGroupTop are both 0 is denoted by reference numeral 1201 in FIG. 12. However, the method described here is one example, and ctxIdx can be derived independently from pos as indicated by reference numeral 1301 in FIG. 13, for example. Reference numeral 1304 in FIG. 13 represents an example in which ctxIdx is derived under the conditions of pos<=4 and pos<=5. As illustrated by reference numeral 1304 in FIG. 13, ctxIdx may be switched depending on two or more conditions.

It is determined whether sigGroupLeft is 1 and sigGroupTop is 0 (S1107). If sigGroupLeft is 1 and sigGroupTop is 0, the horizontal position of the difference coefficient in the sub-block to be processed is determined (S1108). If posX<=1 holds, the context index ctxIdx for decoding the significant coefficient information is set to 1 (S1109), and if not (posX>1), the context index ctxIdx is set to 0 (S1110). The definition of the context index ctxIdx in a case where sigGroupLeft is 1 and sigGroupTop is 0 is denoted by reference numeral 1202 in FIG. 12. However, the method described here is one example, and ctxIdx may be switched depending on two or more conditions as illustrated by reference numeral 1302 in FIG. 13.

It is determined whether sigGroupLeft is 0 and sigGroupTop is 1 (S1111). If sigGroupLeft is 0 and sigGroupTop is 1, the vertical position of the difference coefficient in the sub-block to be processed is determined (S1112). If posY<=1 holds, the context index ctxIdx for decoding the significant coefficient information is set to 1 (S1113), and if not (posY>1), the context index ctxIdx is set to 0 (S1114). The definition of the context index ctxIdx in a case where sigGroupLeft is 0 and sigGroupTop is 1 is denoted by reference numeral 1203 in FIG. 12. In other words, the setting procedure of the context index ctxIdx in the case where sigGroupLeft is 0 and sigGroupTop is 1 is obtained by switching the processing in the X direction and the processing in the Y direction in the case where sigGroupLeft is 1 and sigGroupTop is 0. This facilities the processing to be shared, thereby enabling reduction in the hardware circuit scale or the amount of software codes. However, the method described here is one example, and ctxIdx may be switched depending on two or more conditions as illustrated by reference numeral 1303 in FIG. 13.

If sigGroupLeft is not 0 and sigGroupTop is not 1, that is, if sigGroupLeft is 1 and sigGroupTop is 1, the context index ctxIdx for decoding significant coefficient information is set to 2 independently from pos, posX, or posY (S1115). The definition of the context index ctxIdx in a case where sigGroupLeft is 1 and sigGroupTop is 1 is denoted by reference numeral 1204 in FIG. 12. However, the method described here is one example. The context index ctxIdx may be determined on the basis of the position of the difference coefficient to be processed as indicated by reference numeral 1201 in FIG. 12, or ctxIdx may be switched depending on two or more conditions of the position of the difference coefficient to be processed as indicated by reference numeral 1304 in FIG. 13.

The significant coefficient information coding controller 806 acquires the difference coefficient at the processing target position from the difference coefficient buffer 802. If the value of the difference coefficient is nonzero, the significant coefficient information is set to 1. If not, that is, if the value of the difference coefficient is 0, the significant coefficient information is set to 0. The significant coefficient information coding controller 806 further reads the context corresponding to the determined context index ctxIdx from the context memory 804, and then sends the significant coefficient information and the context to the arithmetic coder 801. The arithmetic coder 801 codes the significant coefficient information using the context (S1116).

### Coding Processing Procedure of Difference Coefficient Value Information (S1005)

The difference coefficient value information coding controller 807 determines a difference coefficient to be processed (S1401). It is assumed that the scanning order of difference coefficients in a sub-block follows the scanning order 202 illustrated in FIG. 2 like the scanning order of significant coefficient information. If all the difference coefficients of the sub-block have been scanned, coding processing of the difference coefficient value information is terminated, and the flow proceeds to a determination procedure of a next sub-block (S901).

The difference coefficient value information coding controller 807 determines whether the value of the difference coefficient at the position of the difference coefficient to be processed is 0 (S1402). If the value of the difference coefficient at the position of the difference coefficient to be processed is 0, coding of the difference coefficient value information at the position of the difference coefficient to be processed is completed, and the flow proceeds to step S901.

If the value of the difference coefficient at the position of the difference coefficient to be processed is nonzero, the difference coefficient absolute value information and the difference coefficient sign information at the position of the difference coefficient to be processed are calculated (S1403 and S1404). Since it is assured that the value of the difference coefficient is nonzero when this procedure is executed, the difference coefficient absolute value information is obtained by subtracting 1 from the absolute value of the difference coefficient. In a case where the difference coefficient is positive, the difference coefficient sign information is set to 0, and in a case where the difference coefficient is negative, the difference coefficient sign information is set to 1.

The difference coefficient value information coding controller 807 reads the context from the context memory 804, and then sends the difference coefficient absolute value information and the context to the arithmetic coder 801. The arithmetic coder 801 codes the difference coefficient absolute value information using the context (S1405).

The difference coefficient value information coding controller 807 reads the context from the context memory 804, and then sends the difference coefficient sign information and the context to the arithmetic coder 801. The arithmetic coder 801 codes the difference coefficient sign information using the context (S1406).

### Decoding Procedure

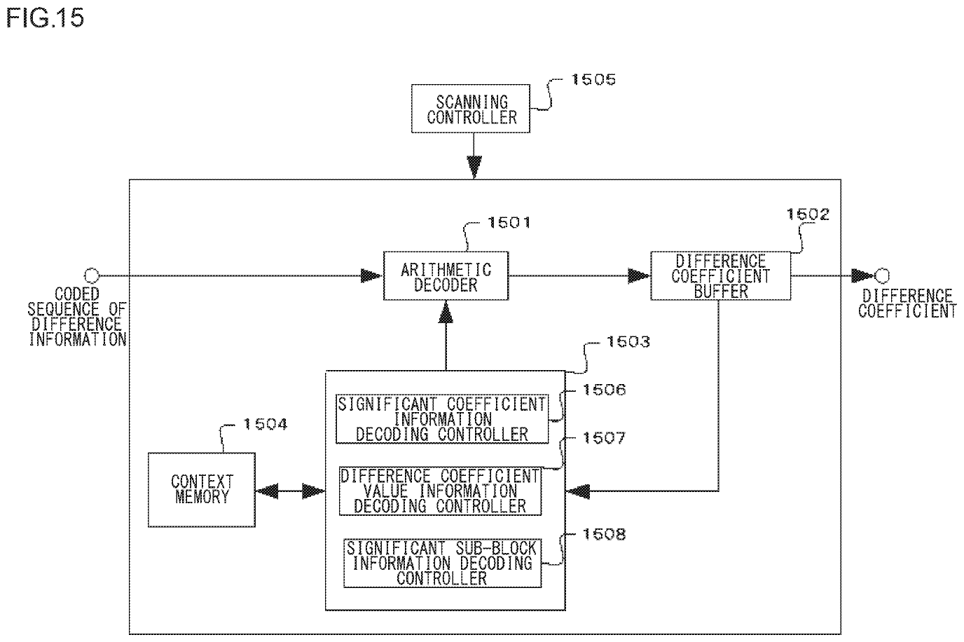

A first example of the difference coefficient decoding method according to the embodiment of the present invention will be described. FIG. 15 is a block diagram of a detailed configuration of the first example of the difference information decoder 601 in FIG. 6. A difference information decoder 601 of the first example includes an arithmetic decoder 1501, a difference coefficient buffer 1502, a decoding controller 1503, a context memory 1504, and a scan controller 1505, and the decoding controller 1503 further includes a significant coefficient information decoding controller 1506, a difference coefficient value information decoding controller 1507, and a significant sub-block information decoding controller 1508.

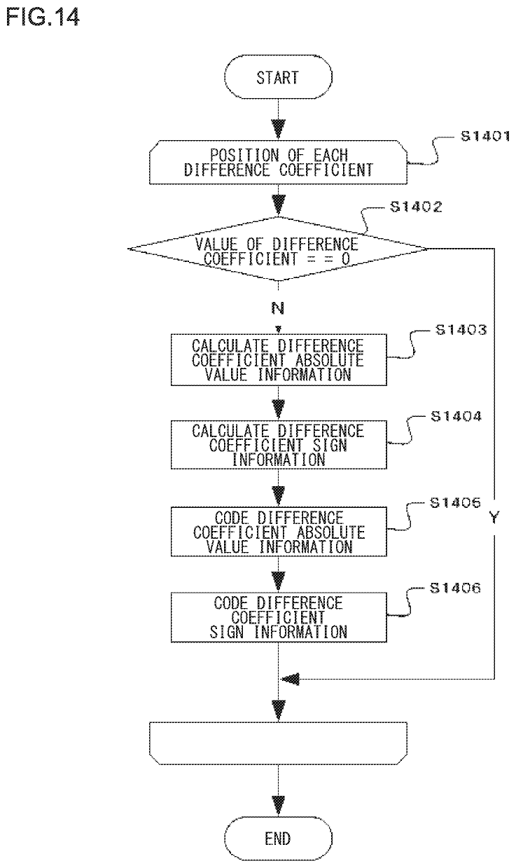

Since difference information decoding processing in the difference information decoder 601 in FIG. 6 corresponds to the difference information coding processing in the difference information coder 507 in FIG. 5, the difference coefficient buffer 1502, the context memory 1504, and the scan controller 1505 in the difference information coder in FIG. 14 have functions corresponding to those of the difference coefficient buffer 802, the context memory 804, and the scan controller 805 in FIG. 8, respectively.

Hereinafter, the decoding procedure of difference information will be described with reference to flowcharts of FIGS. 1, 3, 4, and 16 and the context definitions of FIGS. 12 and 13.

The scan controller 1505 determines a sub-block to be processed (S101). If all the sub-blocks have been scanned, decoding processing of difference coefficients is terminated. A scanning order 202 of sub-blocks is illustrated in FIG. 2. In this procedure, scanning starts from the top left sub-block of the difference coefficient area, then is performed in accordance with the rule of from left to right and from top to bottom, and completes at the bottom right sub-block. Reference numeral 201 in FIG. 2 represents the scanning order of sub-blocks using arrows. When the scanning order in FIG. 2 is followed, processing of sub-blocks located spatially on the left and on top of the sub-block to be processed is completed. Decoding processing of sub-blocks is performed on the sub-block to be processed (S102).

### Sub-Block Decoding Procedure (S102)

The significant sub-block information decoding controller 1508 refers to difference coefficients included in decoded sub-blocks that are adjacent to the sub-block to be processed from the difference coefficient buffer 1502 to determine the context for decoding the significant sub-block information, and reads the determined context from the context memory 1504. A decoding instruction is sent to the arithmetic decoder 1501 together with the context. The arithmetic decoder 1501 performs decoding processing of the coded sequence using the context, and decodes the significant sub-block information (S301).

The significant sub-block information decoding controller 1508 determines the value of the significant sub-block information (S302). If the significant sub-block information is 0, all difference coefficient values of the sub-block to be processed in the difference coefficient buffer 1502 are set to 0 (S305), and the decoding processing of the sub-block difference coefficient value information is terminated.

If the significant sub-block information is 1, decoding processing is performed on all pieces of significant coefficient information of the sub-block to be processed (S303). Details of the decoding procedure of the sub-block significant coefficient information will be described later. After decoding of all pieces of significant coefficient information of the sub-block is completed, the flow proceeds to decoding of difference coefficients in step S304.

Decoding processing is performed on the difference coefficient value information of all the difference coefficients of the sub-block to be processed (S304). Details of the decoding procedure of difference coefficient value information of the sub-block will be described later. After decoding of all the pieces of difference coefficient value information of the sub-block has been completed, the flow proceeds to step S101.

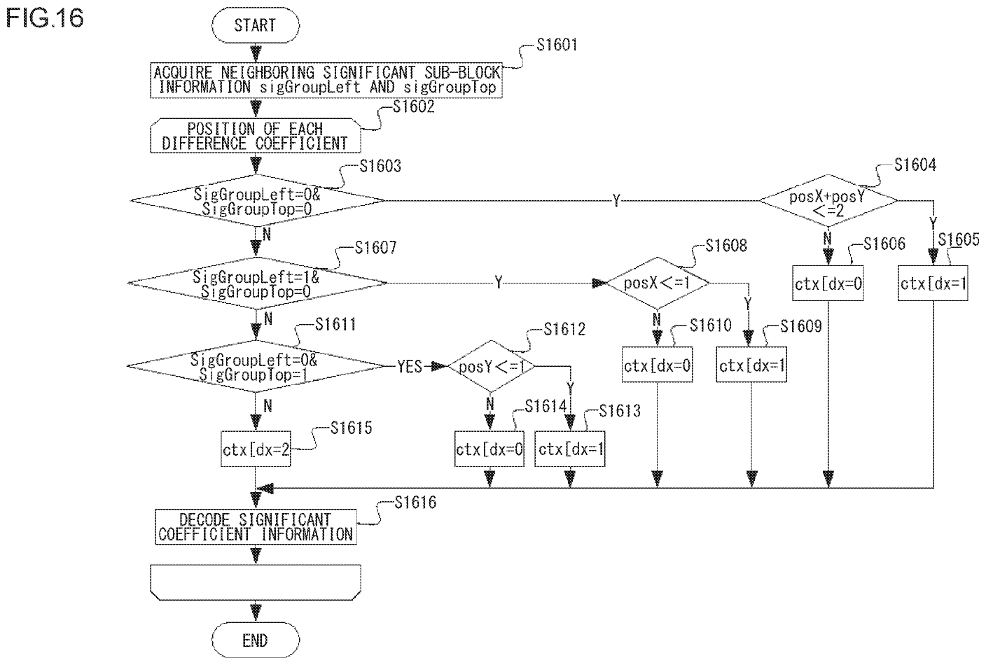

With reference to the flowchart of FIG. 16, a decoding processing procedure of significant coefficient information in the present example will be described.

### Decoding Procedure of Significant Coefficient Information (S303)

The significant coefficient information decoding controller 1506 acquires significant sub-block information of decoded sub-blocks adjacent on the left and on top of the sub-block to be processed as neighboring significant sub-block information. Let the significant sub-block information of the sub-block adjacent on the left be sigGroupLeft, and the significant sub-block information of the sub-block adjacent on top be sigGroupTop (S1601).

The significant coefficient information decoding controller 1506 determines a difference coefficient to be processed (S1602). It is assumed that the scanning order of difference coefficients in a sub-block follows the scanning order 202 illustrated in FIG. 2 like the scanning order of the sub-blocks in the difference coefficient area. If all pieces of the significant coefficient information of the sub-block have been scanned, the decoding processing of the significant coefficient information is terminated, and the flow proceeds to the decoding procedure of the difference coefficient value information (S304).

The significant coefficient information decoding controller 1506 evaluates the neighboring significant sub-block information sigGroupLeft and sigGroupTop (S1603). If sigGroupLeft is 0 and sigGroupTop is 0, the position of the difference coefficient to be processed in the sub-block to be processed is determined (S1604). Let the horizontal position of a difference coefficient be posX, the vertical position of the difference coefficient be posY, and the position of the difference coefficient to be processed be pos=posX+posY. If pos<=2 holds, the context ctxIdx for decoding the significant coefficient information is set to 1 (S1605), and if not (pos>2), the context ctxIdx is set to 0 (S1606). The context definition in a case where sigGroupLeft is 0 and sigGroupTop is 0 is illustrated in a context definition 1201 in FIG. 12. However, the method described here is one example, and ctxIdx can be derived independently from pos as indicated by reference numeral 1301 in FIG. 13, for example. Meanwhile, the context definition 1304 in FIG. 13 illustrates an example in which ctxIdx is derived under the conditions of pos<=4 and pos<=5. As illustrated by the context definition 1304 in FIG. 13, ctxIdx may be switched depending on two or more conditions. After the determined context is read from the context memory 1504, a decoding instruction is sent to the arithmetic decoder 1501 together with the context. The arithmetic decoder 1501 performs decoding processing on the coded sequence using the context, and decodes the significant coefficient information (S1616).

It is determined whether sigGroupLeft is 1 and sigGroupTop is 0 (S1607). If sigGroupLeft is 1 and sigGroupTop is 0, the horizontal position of the difference coefficient in the sub-block to be processed is determined (S1608). If posX<=1 holds, the context index ctxIdx for decoding the significant coefficient information is set to 1 (S1609), and if not (posX>1), the context index ctxIdx is set to 0 (S1610). The context definition in a case where sigGroupLeft is 1 and sigGroupTop is 0 is illustrated in the context definition 1302 in FIG. 13. However, the method described here is one example, and ctxIdx may be switched depending on two or more conditions as illustrated by the context definition 1302 in FIG. 13. After the determined context is read from the context memory 1504, a decoding instruction is sent to the arithmetic decoder 1501 together with the context. The arithmetic decoder 1501 performs decoding processing on the coded sequence using the context, and decodes the significant coefficient information (S1616).

It is determined whether sigGroupLeft is 0 and sigGroupTop is 1 (S1611). If sigGroupLeft is 0 and sigGroupTop is 1, the vertical position of the difference coefficient in the sub-block to be processed is determined (S1612). If posY<=1 holds, the context index ctxIdx for decoding the significant coefficient information is set to 1 (S1613), and if not (posY>1), the context index ctxIdx is set to 0 (S1614). The context definition in a case where sigGroupLeft is 0 and sigGroupTop is 1 is illustrated in the context definition 1203 in FIG. 12. However, the method described here is one example, and ctxIdx may be switched depending on two or more conditions as illustrated by the context definition 1303 in FIG. 13. After the determined context is read from the context memory 1504, a decoding instruction is sent to the arithmetic decoder 1501 together with the context. The arithmetic decoder 1501 performs decoding processing on the coded sequence using the context, and decodes the significant coefficient information (S1616).

If sigGroupLeft is not 0 and sigGroupTop is not 1, that is, if sigGroupLeft and sigGroupTop are both 1, the context index ctxIdx for decoding significant coefficient information is set to 2 independently from pos (S1615). The context definition in a case where sigGroupLeft and sigGroupTop are both 1 is illustrated in the context definition 1204 in FIG. 12. However, the method described here is one example. The context index ctxIdx may be determined on the basis of the position of the difference coefficient to be processed as indicated by the context definition 1201 in FIG. 12, or ctxIdx may be switched depending on two or more conditions of the position of the difference coefficient to be processed as indicated by the context definition 1304 in FIG. 13. After the determined context is read from the context memory 1504, a decoding instruction is sent to the arithmetic decoder 1501 together with the context. The arithmetic decoder 1501 performs decoding processing on the coded sequence using the context, and decodes the significant coefficient information (S1616).

In this procedure, the sum of the number of pieces of significant coefficient information in decoded adjacent sub-blocks and the position of a difference coefficient to be processed in the sub-block are referred to in calculation of the context index ctxIdx for significant coefficient information. The reason for adopting such a configuration will be described below.

In general, orthogonal transform coefficients of a picture tend to concentrate on low-frequency components, and thus the significant coefficient information is likely to be 1. Moreover, since high-frequency components of orthogonal transform coefficients are not easily affected visually and thus are often roughly quantized, a coefficient value of a high-frequency component is likely to be 0, and the significant coefficient information of the high-frequency component is likely to be 0. This property is not limited to the whole difference coefficient area, but similarly applies to each sub-block. A component on the low frequency side of a sub-block is more likely to have significant coefficient information of 1 as compared to a component on the high frequency side of the same sub-block. Setting the value of the context index ctxIdx of significant coefficient information in the low frequency region within a sub-block to be larger than the value of the context index ctxIdx of significant coefficient information in the high frequency region leads to improved estimation accuracy of the probability of occurrence of the significant coefficient information. Also, there is a tendency that in the high frequency region where the probability of significant coefficient information being 0 is high, the neighboring significant coefficient sub-block information is likely to be 0 and that in the low frequency region where the probability of significant coefficient information being 1 is high, the neighboring significant coefficient sub-block information is likely to be 1. Therefore, using the neighboring significant coefficient sub-block information as an index for to what degree significant coefficient information is included in the sub-block to be processed leads to an improvement in the estimation accuracy of the probability of occurrence of significant coefficient information.

In this example, significant sub-block information of processed sub-blocks and the position of the coefficient to be processed are referred to in calculation of the context index; however, the significant sub-block information of the processed sub-blocks is not related to the difference coefficient belonging to the sub-block to be processed. Therefore, there is no dependency among sub-blocks in calculation of the context index. Since it is possible to calculate a context index for all significant coefficients at the head of a sub-block, it is also possible to calculate the context index in parallel with the decoding processing of significant coefficient information. It is possible to reduce a processing delay due to decoding of significant coefficient information that occurs frequently in a coded sequence.

Instead of referring to the significant sub-block information, it is also possible to calculate the context by referring to the sum of significant coefficient information belonging to processed sub-blocks adjacent to the sub-block to be processed. Compared with the configuration that refers to significant sub-block information, it is possible to consider the frequency of occurrence of significant coefficient information adjacent to the sub-block to be processed, thereby enabling an improvement in the coding efficiency.

Alternatively, instead of referring to the significant sub-block information, it is also possible to calculate a context index by using the sum of absolute values of difference coefficients belonging to the processed sub-blocks adjacent to the sub-block to be processed. Since the absolute value of a difference coefficient of a low-frequency component is generally large, it is possible to improve the coding efficiency by setting context that allows the probability of occurrence significant coefficient information to be higher in a case where the sum of the absolute values of neighboring difference coefficients.

It is also possible to improve the accuracy of context estimation by adding the prediction mode used in calculation of difference coefficients to the condition determination in the calculation procedure of the context index of significant coefficients. This is because the inter prediction, in which a plurality of decoded pictures can be referred to, generally has a high prediction accuracy and is unlikely to generate a difference as compared to the intra prediction in which only decoded areas of a picture to be decoded is referred to.

### Decoding Procedure of Difference Coefficient Value Information (S304)

The significant coefficient information decoding controller 1506 determines a difference coefficient to be processed (S401). It is assumed that the scanning order of difference coefficients in a sub-block follows the scanning order 202 illustrated in FIG. 2 like the scanning order of significant coefficients. If all the difference coefficients of the sub-block have been scanned, decoding processing of the difference coefficient value information is terminated, and the flow proceeds to a determination procedure of a next sub-block (S101).

The significant coefficient information decoding controller 1506 determines whether the significant coefficient information of the difference coefficient to be processed is 0 (S402). If the significant coefficient information of the difference coefficient to be processed is 0, decoding of difference coefficient value information of the difference coefficient to be processed is completed, and the flow proceeds to step S401.

If the significant coefficient information of the difference coefficient to be processed is 1, difference coefficient absolute value information of the difference coefficient to be processed is decoded (S403). When this procedure is executed, it is assured that the value of the difference coefficient is nonzero, and difference coefficient absolute value information is obtained by subtracting 1 from the absolute value of the difference coefficient. Therefore, a value obtained by adding 1 to the difference coefficient absolute value information is set as the absolute value of the difference coefficient.

Difference coefficient sign information of the difference coefficient to be processed is decoded (S404). In a case where the difference coefficient sign information is 0, the sign of the value of the difference coefficient is set to be positive, and in a case where the difference coefficient sign information is 1, the sign of the value of the difference coefficient is set to be negative.

In this procedure, for calculation of the context index ctxIdx for significant coefficient information, significant sub-block information of decoded adjacent sub-blocks and the position of a difference coefficient to be processed in the sub-block are referred to, and furthermore significant sub-block information on the left and significant sub-block information on top are individually determined.

The reason for adopting such a configuration will be described below.

In general, orthogonal transform coefficients of a picture tend to concentrate on low-frequency components, and thus the significant coefficient information is likely to be 1. Moreover, since high-frequency components of orthogonal transform coefficients are not easily affected visually and thus are often roughly quantized, the value of a coefficient of a high-frequency component is likely to be 0, and the significant coefficient information of the high-frequency component is likely to be 0. This property is not limited to the whole difference coefficient area, but similarly applies to each sub-block. A component on the low frequency side of a sub-block is more likely to have significant coefficient information of 1 as compared to a component on the high frequency side of the same sub-block. Setting the value of the context index ctxIdx of significant coefficient information in the low frequency region within a sub-block to be larger than the value of the context index ctxIdx of significant coefficient information in the high frequency region leads to improved estimation accuracy of the probability of occurrence of the significant coefficient information. Also, there is a tendency that in the high frequency region where the probability of a significant coefficient being 0 is high, the decoded neighboring significant sub-block information is likely to be small and that in the low frequency region where the probability of a significant coefficient being 1 is high, the decoded neighboring significant sub-block information is also likely to be large. Therefore, using the decoded neighboring significant sub-block information as an index for to what degree significant coefficient information is included in the sub-block to be processed leads to an improvement in the estimation accuracy of the probability of occurrence of significant coefficient information.

In the calculation procedure of the context in the present example, in a case where the significant sub-block information sigGroupLeft on the left is 1 and the significant sub-block information sigGroupTop on top is 0, there is significant coefficient information on the left of the sub-block to be processed. Therefore, there is a high probability that significant coefficient information of the sub-block to be processed on the low frequency side in the horizontal direction becomes 1. On the other hand, the probability of significant coefficient information being 0 increases as it is closer to the high frequency side in the horizontal direction of the sub-block to be processed due to the general characteristic of the orthogonal transform coefficient that a high-frequency component in the horizontal direction is likely to be 0. At this time, since there is no significant coefficient on top of the sub-block to be processed, it is estimated that there is a high probability that the significant coefficient information becomes 0 even in the low frequency region in the vertical direction, and thus the probability of the significant coefficient information being 0 does not vary in the vertical direction. In a case where the significant sub-block information sigGroupLeft on the left is 1 and the significant sub-block information sigGroupTop on top is 0, an appropriate context can be selected due to the configuration of the present example in which the context is derived not on the basis of the vertical position but on the basis of the horizontal position of the significant coefficient information to be processed.

Likewise, in a case where the significant sub-block information sigGroupLeft on the left is 0 and the significant sub-block information sigGroupTop on top is 1, there is significant coefficient information on top of the sub-block to be processed. Therefore, there is a high probability that significant coefficient information of the sub-block to be processed on the low frequency side in the vertical direction becomes 1. On the other hand, the probability of significant coefficient information being 0 increases as it is closer to the high frequency side in the vertical direction of the sub-block to be processed due to the general characteristic of the orthogonal transform coefficient that a high-frequency component in the vertical direction is likely to be 0. At this time, since there is no significant coefficient on the left of the sub-block to be processed, it is estimated that there is a high probability that the significant coefficient information becomes 0 even in the low frequency region in the horizontal direction, and thus the probability of the significant coefficient information being 0 does not vary in the horizontal direction. In a case where the significant sub-block information sigGroupLeft on the left is 0 and the significant sub-block information sigGroupTop on top is 1, an appropriate context can be selected due to the configuration of the present example in which the context is derived not on the basis of the vertical position but on the basis of the horizontal position of the significant coefficient information to be processed. Therefore, by adopting the configuration of the present example, it is possible to determine context that appropriately reflects the neighboring processing results and the characteristics of the orthogonal transform coefficient, thereby enabling improvement in the coding efficiency.

Moreover, from the perspective of reducing the processing amount, a sub-block adjacent on the left of and a sub-block adjacent on top of the sub-block to be decoded are referred to as decoded adjacent sub-blocks in the present example; however, the present invention does not limit decoded adjacent sub-blocks to the above. In particular, the sub-block adjacent to the upper left of the sub-block to be decoded is close to the sub-block to be decoded and has high correlation with the sub-block to be decoded. Therefore, by adding the significant sub-block information sigGroupTopLeft of the sub-block adjacent on the upper left to determination targets for calculation of the context index ctxIndex, the accuracy of the probability of occurrence of a significant coefficient can be improved. However, the sub-block adjacent on the upper left of the sub-block to be decoded is farther away from and has less correlation with the sub-block to be decoded compared to the sub-block adjacent on the left of and the sub-block adjacent on top of the sub-block to be decoded. Therefore, in the configuration in which the context index of a significant coefficient is calculated on the basis of sigGroupLeft, sigGroupTop, and sigGroupTopLeft, it is preferable that the degree of reflection of sigGroupTopLeft to the context index of the significant coefficient is set lower than those of sigGroupTop and sigGroupTopLeft. One approach to set the degree of reflection of sigGroupTopLeft to the context index of a significant coefficient low, for example, the probability of occurrence of significant coefficient information is set low regardless of the value of sigGroupTopLeft in a case where sigGroupTop and sigGroupTopLeft are both 0.

In this example, the significant sub-block information on the left sigGroupLeft, the significant sub-block information on top sigGroupTop, and the position of the coefficient to be processed are referred to; however, the significant sub-block information on the left sigGroupLeft and the significant sub-block information on top sigGroupTop are not related to the difference coefficient belonging to the sub-block to be processed. Therefore, there is no dependency among sub-blocks in calculation of the context index. Since it is possible to calculate a context index for all significant coefficients at the head of a sub-block, it is also possible to calculate the context index in parallel with the decoding processing of significant coefficient information. It is possible to reduce a processing delay due to decoding of significant coefficient information that occurs frequently in a coded sequence.

In this example, a context index for decoding significant coefficient information is calculated from significant sub-block information of decoded sub-blocks; meanwhile, it is also possible to apply a similar procedure to calculation of a context index of the absolute value of a difference coefficient. Since the absolute value of a difference coefficient has a correlation with the absolute value of the neighboring difference coefficients and concentration to the low frequency components like the significant coefficient information does, difference coefficient absolute value information can be efficiently coded by setting a context index indicating that the probability of occurrence of a difference coefficient of a large absolute value is high in a case where the sum of the number of the neighboring significant coefficients or the sum of absolute values of the neighboring difference coefficients is large, and by setting a context index indicating that the probability of occurrence of a difference coefficient of a small absolute value is high in a case where the sum of the number of the neighboring significant coefficients or the sum of absolute values of the neighboring difference coefficients is small.

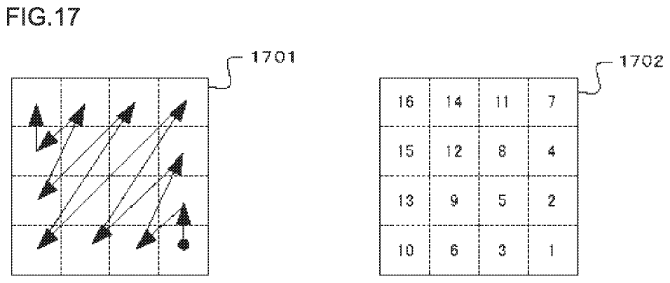

Furthermore, in the present example, the context for coding/decoding significant coefficient information is derived on the basis of coding/decoding information of adjacent sub-blocks and the position of the significant coefficient information to be coded/decoded in the sub-block. None of these depend on the coding/decoding result of the sub-block to which the significant coefficient information to be coded/decoded belongs. Therefore, the scanning order of significant coefficient information in the sub-block is not necessarily the same as the scanning order of significant sub-block information. The scanning order of the significant sub-block information may follow FIG. 2 while the scanning order of the significant coefficient information may be similar to that of HEVC such as from right to left and from bottom to top as illustrated in FIG. 17.

The picture coding device and the picture decoding device of the first example described above exercise the following effects (1) to (4).

(1) The context index of the difference coefficient to be processed can be calculated from difference coefficients belonging to the decoded sub-blocks adjacent to the sub-block to which the difference coefficient to be processed belongs. It is possible to set an appropriate probability model based on the correlation of neighboring significant coefficient information by setting the probability of occurrence of significant coefficient information of 1 to be high in a case where the decoded sub-blocks have non-zero difference coefficients, and setting context that estimates the probability of occurrence of significant coefficient information of 0 to be high in a case where all the difference coefficients belonging to the decoded sub-blocks are 0. Therefore, the significant coefficient information can be efficiently coded.

(2) The context index is calculated on the basis of the position of the difference coefficient to be processed in the sub-block. The context is set in such a manner that the probability for a difference coefficient in the low frequency region in a sub-block to have a significant coefficient of 1 is estimated to be higher than the probability for a difference coefficient in the high frequency region in the sub-block to have a significant coefficient of 1. It is possible to set an appropriate probability model on the basis of the characteristics of significant coefficient information in the frequency regions, thereby enabling efficient coding of the significant coefficient information.

(3) Difference coefficients of decoded sub-blocks and the position of the difference coefficient to be processed in a sub-block do not depend on the decoding result of the significant coefficient information in the sub-block. Therefore, calculation of the context index and decoding of the significant coefficient information in the sub-block can be performed in parallel, and thus it is possible to reduce the processing delay due to the decoding processing of the significant coefficient information. Since difference coefficients have a high ratio of occupancy in a coded sequence, by reducing the processing delay of the significant coefficient information having a large number of times of processing, a decoding device suitable for real-time processing can be implemented. The processing delay in coding of significant coefficient information can be similarly reduced also in a coding device.

(4) A context index is calculated on the basis of the combination of significant sub-block information on the left and significant sub-block information on top. It is possible to estimate a high probability for significant coefficient information of a low-frequency component in the vertical direction of the sub-block to be processed to be 1 and to estimate a low probability for significant coefficient information of a high-frequency component in the horizontal direction to be 1 in a case where there is a significant coefficient on top of the sub-block to be processed. Meanwhile, in a case where there is a significant coefficient on the left of the sub-block to be processed, it is possible to estimate a high probability for significant coefficient information of a low-frequency component in the horizontal direction of the sub-block to be processed to be 1 and to estimate a low probability for significant coefficient information of a high-frequency component in the vertical direction to be 1. Therefore, by adopting such a configuration, a probability model of significant coefficient information can be appropriately set in the configuration in which the sub-blocks are scanned from left to right and from top to bottom, thereby enabling efficient coding of the significant coefficient information.

### Second Example

A second example of the difference information coding method according to the embodiment of the present invention will be described. Like the difference information coder 507 of the first example illustrated in FIG. 8, a difference information coder 507 of the second example includes an arithmetic coder 801, a difference coefficient buffer 802, a coding controller 803, a context memory 804, and a scan controller 805, and the coding controller 803 further includes a significant coefficient information coding controller 806, a difference coefficient value information coding controller 807, and a significant sub-block information coding controller 808.

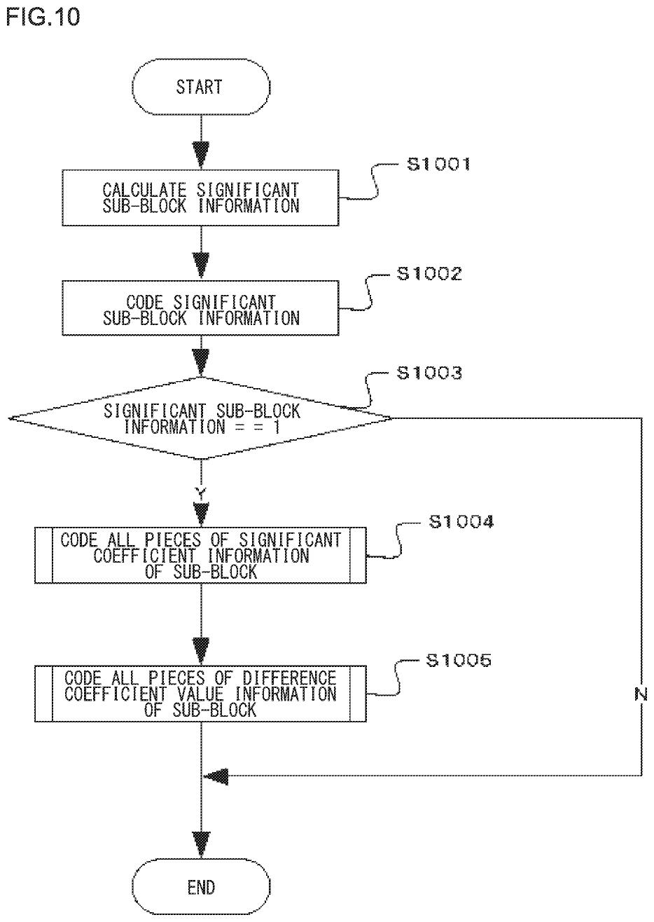

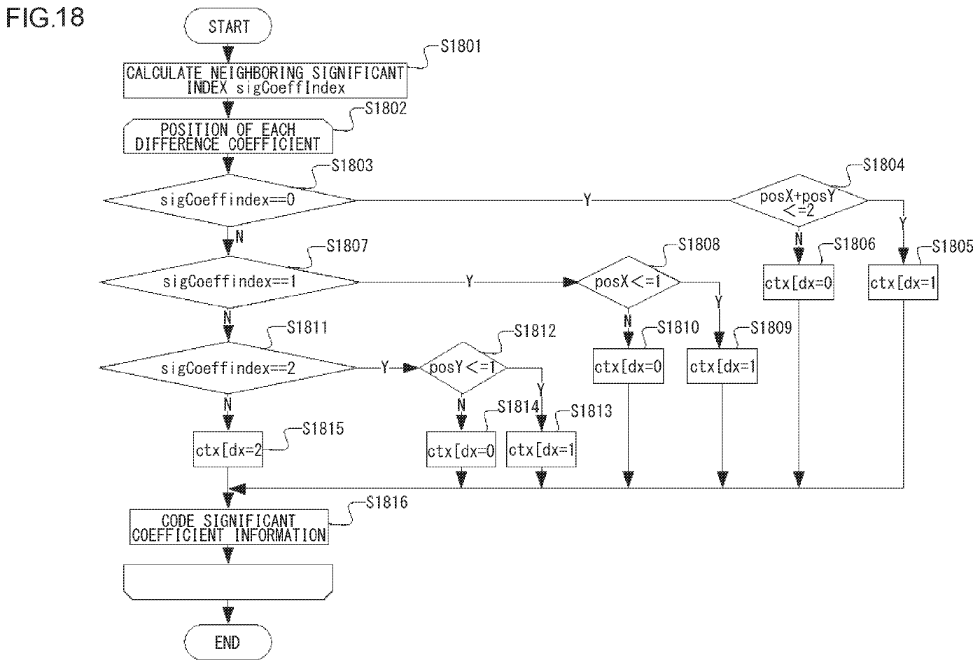

The coding procedure of difference information in this example is similar to that of the first example except for the coding processing procedure of significant coefficient information (S1004 in FIG. 10), and thus a coding processing procedure of significant coefficient information in the present example will be described with reference to a flowchart in FIG. 18.

### Coding Processing Procedure of Significant Coefficient Information (S1004)

The significant coefficient information coding controller 806 calculates a neighboring significant index sigCoeffIndex from significant sub-block information of decoded sub-blocks adjacent on the left of and on top of the sub-block to be processed. Let the significant sub-block information of the sub-block adjacent on the left be sigGroupLeft, the significant sub-block information of the sub-block adjacent on top be sigGroupTop, and the neighboring significant index be sigCoeffIndex=sigGroupLeft+2×sigGroupTop (S1801).

The significant coefficient information coding controller 806 determines a difference coefficient to be processed (S1802). It is assumed that the scanning order of difference coefficients in a sub-block follows the scanning order 202 illustrated in FIG. 2 like the scanning order of the sub-blocks in the difference coefficient area. If all the significant coefficient in the sub-block have been scanned, the coding processing of the significant coefficients is terminated, and the flow proceeds to the coding procedure of the difference coefficient value (S1005).

The significant coefficient information coding controller 806 evaluates the neighboring significant index sigCoeffIndex (S1803).

If the neighboring significant index sigCoeffIndex is 0, the position of the difference coefficient to be processed in the sub-block to be processed is determined (S1804). The neighboring significant index sigCoeffIndex being 0 indicates that sigGroupLeft is 0 and that sigGroupTop is 0. Let the horizontal position of a difference coefficient be posX, the vertical position of the difference coefficient be posY, and the position of the difference coefficient to be processed be pos=posX+posY. If pos<=2 holds, the context index ctxIdx for coding the significant coefficient information is set to 1 (S1805), and if not (pos>2), the context index ctxIdx is set to 0 (S1806). The definition of the context index ctxIdx in a case where the neighboring significant index sigCoeffIndex is 0 is illustrated in the context definition 1201 of FIG. 12.

It is determined whether the neighboring significant index sigCoeffIndex is 1 (S1807). The neighboring significant index sigCoeffIndex being 1 indicates that sigGroupLeft is 1 and that sigGroupTop is 0. If the neighboring significant index sigCoeffIndex is 1, the horizontal position of the difference coefficient in the sub-block to be processed is determined (S1808). If posX<=1 holds, the context index ctxIdx for decoding the significant coefficient information is set to 1 (S1809), and if not (posX>1), the context index ctxIdx is set to 0 (S1810). The definition of the context index ctxIdx in a case where the neighboring significant index sigCoeffIndex is 1 is illustrated in the context definition 1202 of FIG. 12.

It is determined whether the neighboring significant index sigCoeffIndex is 2 (S1811). The neighboring significant index sigCoeffIndex being 2 indicates that sigGroupLeft is 0 and that sigGroupTop is 1. If the neighboring significant index sigCoeffIndex is 2, the vertical position of the difference coefficient in the sub-block to be processed is determined (S1812). If posY<=1 holds, the context index ctxIdx for decoding the significant coefficient information is set to 1 (S1813), and if not (posY>1), the context index ctxIdx is set to 0 (S1814). The definition of the context index ctxIdx in a case where the neighboring significant index sigCoeffIndex is 2 is illustrated in the context definition 1203 of FIG. 12. In other words, the setting procedure of the context index ctxIdx in the case where the neighboring significant index sigCoeffIndex is 2 is obtained by switching the processing in the X direction and the processing in the Y direction in the case where the neighboring significant index sigCoeffIndex is 1. This facilities the processing to be shared, thereby enabling reduction in the hardware circuit scale or the amount of software codes.

If the neighboring significant index sigCoeffIndex is not 2, that is, if the neighboring significant index sigCoeffIndex is 3, the context index ctxIdx for decoding the significant coefficient information is set to 2 independently from pos (S1815). The definition of the context index ctxIdx in a case where the neighboring significant index sigCoeffIndex is 3 is illustrated in the context definition 1204 of FIG. 12.

The significant coefficient information coding controller 806 acquires the difference coefficient at the processing target position from the difference coefficient buffer 802. If the value of the difference coefficient is nonzero, the significant coefficient information is set to 1. If not (if the value of the difference coefficient is 0), the significant coefficient information is set to 0. The significant coefficient information coding controller 806 further reads the context corresponding to the determined context index ctxIdx from the context memory 804, and then sends the significant coefficient information and the context to the arithmetic coder 801. The arithmetic coder 801 codes the significant coefficient information using the context (S1816).

### Decoding Procedure

A second example of the difference coefficient decoding method according to the embodiment of the present invention will be described. Like the difference information decoder 601 of the first example illustrated in FIG. 15, a difference information decoder 601 of the second example includes an arithmetic decoder 1501, a difference coefficient buffer 1502, a decoding controller 1503, a context memory 1504, and a scan controller 1505, and the decoding controller 1503 further includes a significant coefficient information decoding controller 1506, a difference coefficient value information decoding controller 1507, and a significant sub-block information decoding controller 1508.

Since difference information decoding processing in the difference information decoder 601 in FIG. 6 corresponds to the difference information coding processing in the difference information coder 507 in FIG. 5, the difference coefficient buffer 1502, the context memory 1504, and the scan controller 1505 in the difference information coder in FIG. 15 have functions corresponding to those of the difference coefficient buffer 802, the context memory 804, and the scan controller 805 in FIG. 8, respectively.

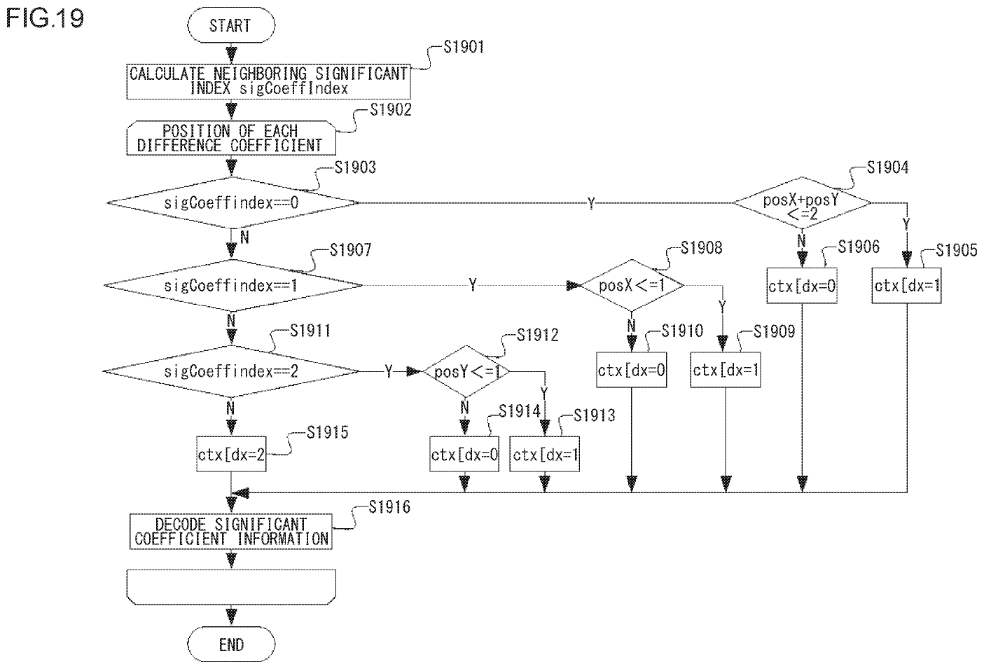

The decoding procedure of difference information in this example is similar to that of the first example except for the coding processing procedure of significant coefficient information (S303 in FIG. 3), and thus a decoding processing procedure of significant coefficient information in the present example will be described with reference to a flowchart in FIG. 19.

### Decoding Procedure of Significant Coefficient Information (S303)

The significant coefficient information decoding controller 1506 calculates a neighboring significant index sigCoeffIndex from significant sub-block information of decoded sub-blocks adjacent on the left of and on top of the sub-block to be processed. Let the significant sub-block information of the sub-block adjacent on the left be sigGroupLeft, the significant sub-block information of the sub-block adjacent on top be sigGroupTop, and the neighboring significant index be sigCoeffIndex=sigGroupLeft+2×sigGroupTop (S1901).

The significant coefficient information decoding controller 1506 determines a difference coefficient to be processed (S1902). It is assumed that the scanning order of difference coefficients in a sub-block follows the rule illustrated in FIG. 7 like the scanning order of the sub-blocks in the difference coefficient area. If all significant coefficients of the sub-block have been scanned, the decoding processing of the significant coefficient is terminated, and the flow proceeds to the decoding procedure of the difference coefficient value (S304).

The significant coefficient information decoding controller 1506 evaluates the neighboring significant index sigCoeffIndex (S1903).

If the neighboring significant index sigCoeffIndex is 0, the position of the difference coefficient to be processed in the sub-block to be processed is determined (S1904). The neighboring significant index sigCoeffIndex being 0 indicates that sigGroupLeft and sigGroupTop are both 0. Let the horizontal position of a difference coefficient be posX, the vertical position of the difference coefficient be posY, and the position of the difference coefficient to be processed be pos=posX+posY. If pos<=2 holds, the context ctxIdx for decoding the significant coefficient information is set to 1 (S1905), and if not (pos >2), the context ctxIdx is set to 0 (S1906). The context definition in a case where the neighboring significant index sigCoeffIndex is 0 is illustrated in the context definition 1201 of FIG. 12. After the determined context is read from the context memory 1504, a decoding instruction is sent to the arithmetic decoder 1501 together with the context. The arithmetic decoder 1501 performs decoding processing on the coded sequence using the context, and decodes the significant coefficient information (S1916).

It is determined whether the neighboring significant index sigCoeffIndex is 1 (S1907). The neighboring significant index sigCoeffIndex being 1 indicates that sigGroupLeft is 1 and that sigGroupTop is 0. If the neighboring significant index sigCoeffIndex is 1, the horizontal position of the difference coefficient in the sub-block to be processed is determined (S1908). If posX<=1 holds, the context index ctxIdx for decoding the significant coefficient information is set to 1 (S1909), and if not (pos>1), the context index ctxIdx is set to 0 (S1910). The context definition in a case where the neighboring significant index sigCoeffIndex is 1 is illustrated in the context definition 1202 of FIG. 12. After the determined context is read from the context memory 1504, a decoding instruction is sent to the arithmetic decoder 1501 together with the context. The arithmetic decoder 1501 performs decoding processing on the coded sequence using the context, and decodes the significant coefficient information (S1916).

It is determined whether the neighboring significant index sigCoeffIndex is 2 (S1911). The neighboring significant index sigCoeffIndex being 2 indicates that sigGroupLeft is 0 and that sigGroupTop is 1. If the neighboring significant index sigCoeffIndex is 2, the vertical position of the difference coefficient in the sub-block to be processed is determined (S1912). If posY<=1 holds, the context index ctxIdx for decoding the significant coefficient information is set to 1 (S1913), and if not (posY>1), the context index ctxIdx is set to 0 (S1914). The context definition in a case where the neighboring significant index sigCoeffIndex is 2 is illustrated in the context definition 1203 of FIG. 12. After the determined context is read from the context memory 1504, a decoding instruction is sent to the arithmetic decoder 1501 together with the context. The arithmetic decoder 1501 performs decoding processing on the coded sequence using the context, and decodes the significant coefficient information (S1916).

If the neighboring significant index sigCoeffIndex is not 2, that is, if the neighboring significant index sigCoeffIndex is 3, the context index ctxIdx for decoding the significant coefficient information is set to 2 independently from pos (S1915). The context definition in a case where the neighboring significant index sigCoeffIndex is 3 is illustrated in the context definition 1204 of FIG. 12. After the determined context is read from the context memory 1504, a decoding instruction is sent to the arithmetic decoder 1501 together with the context. The arithmetic decoder 1501 performs decoding processing on the coded sequence using the context, and decodes the significant coefficient information (S1916).

The present example is different from the first example in that the context index ctxIdx is calculated by referring to the neighboring significant index sigCoeffIndex after calculating the neighboring significant index sigCoeffIndex on the basis of sigGroupLeft and sigGroupTop, instead of directly referring to the significant sub-block information sigGroupLeft of the sub-block adjacent on the left and the significant sub-block information sigGroupTop of the sub-block adjacent on top in the procedure of calculating the context index ctxIdx of the significant coefficient information. Therefore, it is possible to reduce the number of times of determination processing related to the neighboring significant index sigCoeffIndex context index.

The picture coding device and the picture decoding device of the second example described above exercise the following effect (5) in addition to the effects (1) to (4) of the first example described above.

(5) After calculating the neighboring significant index sigCoeffIndex on the basis of the significant sub-block information of the sub-block adjacent on the left sigGroupLeft and the significant sub-block information of the sub-block adjacent on top sigGroupTop, the context index is calculated on the basis of the neighboring significant index sigCoeffIndex. This can reduce the number of times of determination processing related to calculation of the context index compared with the method of calculating the context index on the basis of the significant sub-block information sigGroupLeft of the sub-block adjacent on the left and the significant sub-block information sigGroupTop of the sub-block adjacent on top.

A bitstream of the picture output from the picture coding device according to the embodiment described above has a specific data format so that it can be decoded in accordance with the coding method used in the embodiment, and thus a picture decoding device corresponding to the picture coding device can decode the bitstream of this specific data format.

In a case where a wired or wireless network is used to exchange a bitstream between a picture coding device and a picture decoding device, the bitstream may be converted into a data format suitable for the transmission mode of the communication path and be transmitted. In this case, a picture transmission device that converts the bitstream output from the picture coding device into coded data in a data format suitable for the transmission mode of the communication path and transmits the coded data to a network, as well as a picture receiving device that receives the coded data from the network, restores into a bitstream, and supplies the bitstream to the picture decoding device are provided

The picture transmission device includes a memory that buffers a bitstream output from the picture coding device, a packet processor that packetizes the bitstream, and a transmitter that transmits packetized coded data via the network. The picture receiving device includes a receiver that receives the packetized coded data via the network, a memory that buffers the received coded data, and a packet processor that generates a bitstream by performing packet processing on the coded data and provides the bitstream to the picture decoding device.

It is understood without saying that the above processing related to coding and decoding can be implemented by transmission/storage/reception devices using hardware, and the above processing may be also implemented by firmware stored in a read only memory (ROM), flash memory, etc., or software for computers. The firmware program or the software program may be recorded in a recording medium readable by computers and thereby provided, may be provided from a server through a wired or wireless network, or may be provided as data broadcasting of terrestrial or satellite digital broadcasting.

The present invention has been described above on the basis of the embodiments. These embodiments are merely examples. Therefore, it should be understood by a person skilled in the art that combinations of the components or processing processes of the examples may include various variations and that such a variation is also within the scope of the present invention.

What is claimed is:

1. A picture coding device structured to partition difference information between a picture to be coded and a picture to be predicted into a plurality of sub-blocks and to code the partitioned sub-blocks in an order from left to right and from top to bottom, the picture coding device comprising:
a significant sub-block information coder structured to code significant sub-block information indicating whether all values of difference coefficients belonging to the sub-block are zero;
a significant coefficient information coder structured to code significant coefficient information indicating whether a value of a difference coefficient is zero;
a difference coefficient value information coder structured to code the value of the difference coefficient; and
a context deriver structured to derive context for coding the significant coefficient information to be coded on the basis of significant sub-block information of a coded sub-block adjacent on a left of a sub-block to be coded, significant sub-block information of a coded sub-block adjacent on top of the sub-block to be coded, and a position of the difference coefficient to be coded in the sub-block to be coded,
wherein the context deriver derives the context of the significant coefficient information to be coded on the basis of a horizontal position of the significant coefficient information to be coded in the sub-block to be coded in a case where the significant sub-block information of the coded sub-block adjacent on the left is one and the significant sub-block information of the coded sub-block adjacent on top is zero, and
derives the context of the significant coefficient information to be coded on the basis of a vertical position of the significant coefficient information to be coded in the sub-block to be coded in a case where the significant sub-block information of the coded sub-block adjacent on the left is zero and the significant sub-block information of the coded sub-block adjacent on top is one.

2. A picture coding method for partitioning difference information between a picture to be coded and a picture to be predicted into a plurality of sub-blocks and coding the partitioned sub-blocks in an order from left to right and from top to bottom, the picture coding method comprising:
a significant sub-block information coding step of coding significant sub-block information indicating whether all values of difference coefficients belonging to the sub-block are zero;
a significant coefficient information coding step of coding significant coefficient information indicating whether a value of a difference coefficient is zero;
a difference coefficient value information coding step of coding the value of the difference coefficient; and
a context deriving step of deriving context for coding the significant coefficient information to be coded on the basis of significant sub-block information of a coded sub-block adjacent on a left of a sub-block to be coded, significant sub-block information of a coded sub-block adjacent on top of the sub-block to be coded, and a position of the difference coefficient to be coded in the sub-block to be coded,
wherein the context deriving step derives the context of the significant coefficient information to be coded on the basis of a horizontal position of the significant coefficient information to be coded in the sub-block to be coded in a case where the significant sub-block information of the coded sub-block adjacent on the left is one and the significant sub-block information of the coded sub-block adjacent on top is zero, and derives the context of the significant coefficient information to be coded on the basis of a vertical position of the significant coefficient information to be coded in the sub-block to be coded in a case where the significant sub-block information of the coded sub-block adjacent on the left is zero and the significant sub-block information of the coded sub-block adjacent on top is one.

3. A non-transitory recording medium storing a computer-readable picture coding program, the picture coding program causing a computer to partition difference information between a picture to be coded and a picture to be predicted into a plurality of sub-blocks and to code the partitioned sub-blocks in an order from left to right and from top to bottom, the picture coding program causing the computer to perform:
a significant sub-block information coding step of coding significant sub-block information indicating whether all values of difference coefficients belonging to the sub-block are zero;
a significant coefficient information coding step of coding significant coefficient information indicating whether a value of a difference coefficients is zero;
a difference coefficient value information coding step of coding the value of the difference coefficient; and
a context deriving step of deriving context for coding the significant coefficient information to be coded on the basis of significant sub-block information of a coded sub-block adjacent on a left of a sub-block to be coded, significant sub-block information of a coded sub-block adjacent on top of the sub-block to be coded, and a position of the difference coefficient to be coded in the sub-block to be coded,
wherein the context deriving step derives the context of the significant coefficient information to be coded on the basis of a horizontal position of the significant coefficient information to be coded in the sub-block to be coded in a case where the significant sub-block information of the coded sub-block adjacent on the left is one and the significant sub-block information of the coded sub-block adjacent on top is zero, and derives the context of the significant coefficient information to be coded on the basis of a vertical position of the significant coefficient information to be coded in the sub-block to be coded in a case where the significant sub-block information of the coded sub-block adjacent on the left is zero and the significant sub-block information of the coded sub-block adjacent on top is one.

4. A picture decoding device structured to decode a bitstream obtained by partitioning difference information between a picture to be decoded and a picture to be predicted into a plurality of sub-blocks and coding the partitioned sub-blocks in an order from left to right and from top to bottom, the picture decoding device comprising:
a significant sub-block information decoder structured to decode significant sub-block information indicating whether all values of difference coefficients belonging to the sub-block are zero;
a significant coefficient information decoder structured to decode significant coefficient information indicating whether a value of a difference coefficient is zero;
a difference coefficient value information decoder structured to decode the value of the difference coefficient; and
a context deriver structured to derive context for decoding the significant coefficient information to be decoded on the basis of significant sub-block information of a decoded sub-block adjacent on a left of a sub-block to be decoded, significant sub-block information of a decoded sub-block adjacent on top of the sub-block to be decoded, and a position of the difference coefficient to be decoded in the sub-block to be decoded,
wherein the context deriver derives the context of the significant coefficient information to be decoded on the basis of a horizontal position of the significant coefficient information to be decoded in the sub-block to be decoded in a case where the significant sub-block information of the decoded sub-block adjacent on the left is one and the significant sub-block information of the decoded sub-block adjacent on top is zero, and derives the context of the significant coefficient information to be decoded on the basis of a vertical position of the significant coefficient information to be decoded in the sub-block to be decoded in a case where the significant sub-block information of the decoded sub-block adjacent on the left is zero and the significant sub-block information of the decoded sub-block adjacent on top is one.

5. A picture decoding method for decoding a bitstream obtained by partitioning difference information between a picture to be decoded and a picture to be predicted into a plurality of sub-blocks and coding the partitioned sub-blocks in an order from left to right and from top to bottom, the picture decoding method comprising:
a significant sub-block information decoding step of decoding significant sub-block information indicating whether all values of difference coefficients belonging to the sub-block are zero;
a significant coefficient information decoding step of decoding significant coefficient information indicating whether a value of a difference coefficient is zero;
a difference coefficient value information decoding step of decoding the value of the difference coefficient; and
a context deriving step of deriving context for decoding the significant coefficient information to be decoded on the basis of significant sub-block information of a decoded sub-block adjacent on a left of a sub-block to be decoded, significant sub-block information of a decoded sub-block adjacent on top of the sub-block to be decoded, and a position of the difference coefficient to be decoded in the sub-block to be decoded,
wherein the context deriving step derives the context of the significant coefficient information to be decoded on the basis of a horizontal position of the significant coefficient information to be decoded in the sub-block to be decoded in a case where the significant sub-block information of the decoded sub-block adjacent on the left is one and the significant sub-block information of the decoded sub-block adjacent on top is zero, and
derives the context of the significant coefficient information to be decoded on the basis of a vertical position of the significant coefficient information to be decoded in the sub-block to be decoded in a case where the significant sub-block information of the decoded sub-block adjacent on the left is zero and the significant sub-block information of the decoded sub-block adjacent on top is one.

6. A non-transitory recording medium storing a computer-readable picture decoding program, the picture decoding program causing a computer to decode a bitstream obtained by partitioning difference information between a picture to be decoded and a picture to be predicted into a plurality of sub-blocks and coding the partitioned sub-blocks in an order from left to right and from top to bottom, the picture decoding program causing the computer to perform:
a significant sub-block information decoding step of decoding significant sub-block information indicating whether all values of difference coefficients belonging to the sub-block are zero;
a significant coefficient information decoding step of decoding significant coefficient information indicating whether a value of a difference coefficient is zero;
a difference coefficient value information decoding step of decoding the value of the difference coefficient; and
a context deriving step of deriving a context for decoding the significant coefficient information to be decoded on the basis of significant sub-block information of a decoded sub-block adjacent on a left of a sub-block to be decoded, significant sub-block information of a decoded sub-block adjacent on top of the sub-block to be decoded, and a position of the difference coefficient to be decoded in the sub-block to be decoded,
wherein the context deriving step derives the context of the significant coefficient information to be decoded on the basis of a horizontal position of the significant coefficient information to be decoded in the sub-block to be decoded in a case where the significant sub-block information of the decoded sub-block adjacent on the left is one and the significant sub-block information of the decoded sub-block adjacent on top is zero, and derives the context of the significant coefficient information to be decoded on the basis of a vertical position of the significant coefficient information to be decoded in the sub-block to be decoded in a case where the significant sub-block information of the decoded sub-block adjacent on the left is zero and the significant sub-block information of the decoded sub-block adjacent on top is one.
